(19) United States
(12) Patent Application Publication
(10) Pub. No.: US 2026/0310753 A1
(43) Pub. Date: Oct. 8, 2026

(54) SYSTEMS AND METHODS FOR INTERNET-OF-THINGS MANAGEMENT THROUGH GENERALIZED AUTONOMOUS INTELLIGENT AGENT ARCHITECTURES

(71) Applicant: Abysius Inc., Minnetonka, MN (US)

(72) Inventor: Kevin Friesth, Fort Dodge, IA (US)

(73) Assignee: Abysius Inc., Minnetonka, MN (US)

(21) Appl. No.: 19/637,585

(22) Filed: Apr. 2, 2026

Related U.S. Application Data
(60) Provisional application No. 63/782,273, filed on Apr. 2, 2025.

(51) Int. Cl. G06F 18/21; G06F 16/903; G06N 5/022

(52) U.S. Cl. CPC G06F 18/2178; G06F 16/90335; G06N 5/022

(57) ABSTRACT

Systems and methods provide a framework for the integration of generalized autonomous intelligent agents within user environments for the automated management and monitoring of Internet-of-Things (IoT) devices within the user environments. Generalized autonomous intelligent agents implemented within these user environments can dynamically process real-time IoT data and user communications within the user environment to provide tailored responses and to modify these user environments through dynamic manipulation of different IoT devices within these user environments.

### CROSS-REFERENCE TO RELATED APPLICATIONS

The present patent application claims the priority benefit of U.S. Provisional Patent Application Number 63/782,273 filed Apr. 2, 2025, the disclosures of which are incorporated by reference herein.

### FIELD

The present disclosure relates generally to systems and methods for the integration of generalized autonomous intelligent agents within user environments for the automated management and monitoring of Internet-of-Things (IoT) devices within the user environments. Generalized autonomous intelligent agents implemented within these user environments can dynamically process real-time IoT data and user communications within the user environment to provide tailored responses and to modify these user environments through dynamic manipulation of different IoT devices within these user environments.

### SUMMARY

Disclosed embodiments provide a framework for the integration of generalized autonomous intelligent agents within user environments for the automated management and monitoring of IoT devices within the user environments. According to some embodiments, a computer-implemented method is provided. The computer-implemented method comprises detecting a user prompt. The user prompt is associated with an intent. Furthermore, the user prompt is received through a generalized autonomous intelligent agent implemented on an IoT device operating in a user environment. The computer-implemented method further comprises processing the user prompt to identify an intent. The intent is associated with one or more knowledge domains. The computer-implemented method further comprises identifying a set of domain-specific artificial intelligence models trained according to the one or more knowledge domains. The computer-implemented method further comprises transmitting the user prompt to the set of domain-specific artificial intelligence models to solicit a response to the user prompt. When the user prompt is received by the set of domain-specific artificial intelligence models, the set of domain-specific artificial intelligence models collaboratively process the user prompt according to the one or more knowledge domains to generate a set of responses. The computer-implemented method further comprises evaluating the set of responses to generate a tailored response according to a set of user characteristics associated with a user. The computer-implemented method further comprises transmitting the tailored response through the IoT device operating in the user environment. The computer-implemented method further comprises dynamically updating the generalized autonomous intelligent agent, the set of domain-specific artificial intelligence models, and the set of user characteristics according to feedback associated with the tailored response. The feedback is obtained through the IoT device.

In some embodiments, the set of domain-specific artificial intelligence models is implemented in a remote computing environment. Furthermore, the user environment and the remote computing environment are distinct.

In some embodiments, the tailored response includes one or more executable commands that, when executed by one or more other IoT devices within the user environment, cause the one or more IoT devices to perform a set of operations to address the intent.

In some embodiments, the user prompt further includes IoT data corresponding to one or more other IoT devices within the user environment. Further, the IoT data is processed by the generalized autonomous intelligent agent to identify the intent.

In some embodiments, the feedback includes IoT data corresponding to one or more other IoT devices within the user environment. Further, the IoT data is evaluated by the generalized autonomous intelligent agent to determine whether the intent has been addressed.

In some embodiments, the computer-implemented method further comprises identifying a new knowledge domain corresponding to the intent. The computer-implemented method further comprises training a new domain-specific artificial intelligence model according to the new knowledge domain. The new domain-specific artificial intelligence model is trained by extracting data from different data sources corresponding to the new knowledge domain. The computer-implemented method further comprises transmitting the user prompt to the new domain-specific artificial intelligence model. When the user prompt is received by the new domain-specific artificial intelligence model, the new domain-specific artificial intelligence model collaboratively processes the user prompt with the set of domain-specific artificial intelligence models to generate a new response.

In some embodiments, the set of responses is further evaluated by another generalized autonomous intelligent agent implemented in a remote computing environment to obtain an additional tailored response to the user prompt. Further, the additional tailored response is transmitted through the IoT device operating in the user environment.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which a generalized autonomous intelligent agent implemented on an IoT device within a user environment dynamically processes user communications and IoT data from other devices and sensors to generate tailored responses and executable instructions for the other devices and sensors in accordance with at least one embodiment;

FIG. 2 shows an illustrative example of an environment in which a generalized autonomous intelligent agent, through a set of specialized modules implemented on an IoT device, provides tailored responses and executable instructions for other devices and sensors within a user environment according to specific knowledge domains in accordance with at least one embodiment;

FIG. 3 shows an illustrative example of an environment in which a generalized autonomous intelligent agent implemented on an IoT device within a user environment dynamically transmits IoT data to another generalized autonomous intelligent agent implemented in a remote computing environment to obtain tailored responses and executable instructions in accordance with at least one embodiment;

FIG. 4 shows an illustrative example of a process for autonomously generating responses to user prompts through domain-specific AI models and emotional intelligence processing in accordance with at least one embodiment;

FIG. 5 shows an illustrative example of a process for autonomously processing device and sensor data corresponding to different devices and sensors implemented in a user environment to generate tailored executable instructions and commands for the different devices and sensors in accordance with at least one embodiment; and

FIG. 6 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing preferred examples of embodiments. It is understood that various changes can be made in the function and arrangement of elements without departing from the spirit and scope as set forth in the appended claims.

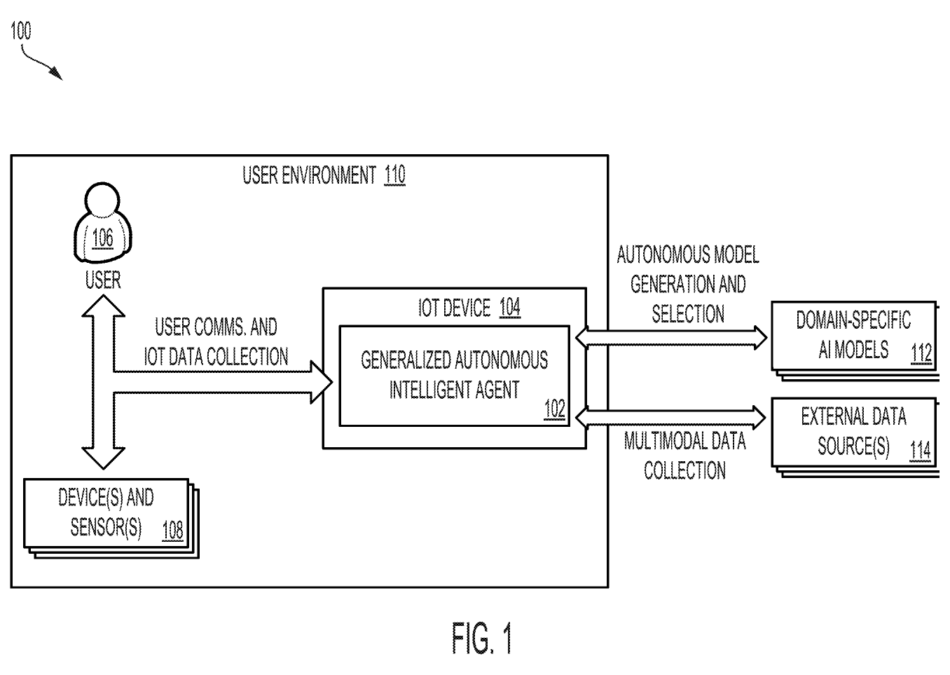

FIG. 1 shows an illustrative example of an environment 100 in which a generalized autonomous intelligent agent 102 implemented on an IoT device 104 within a user environment 110 dynamically processes user communications and IoT data from other devices and sensors 108 to generate tailored responses and executable instructions for the other devices and sensors 108 in accordance with at least one embodiment. In the environment 100, an IoT device 104 is implemented to dynamically, and in real-time or near real-time, monitor a user environment 110 for user prompts from users (including user 106) and data from different devices and/or sensors 108 implemented within the user environment 110. In an embodiment, the IoT device 104 implements a generalized autonomous intelligent agent 102, which may dynamically process these user prompts and data to generate different outputs that may be provided to the user 106 in response to their user prompts, as well as different executable instructions that may be transmitted to the devices and/or sensors 108 within the user environment 110 to cause these devices and/or sensors 108 to perform desired operations.

In an embodiment, the generalized autonomous intelligent agent 102 implemented on the IoT device 104 is dynamically trained to implement and leverage domain-specific AI models 112 to provide sophisticated and refined responses to user prompts and other requests. The domain-specific AI models 112, as described in greater detail herein, may be implemented by the generalized autonomous intelligent agent 102 through the IoT device 104. Alternatively, the domain-specific AI models 112 may be implemented through a remote computing environment that may be external to the user environment 110 and accessed through a network communications session between the IoT device 104 and one or more computing devices (e.g., servers, etc.) of the remote computing environment. The generalized autonomous intelligent agent 102 may be dynamically trained using fuzzy logic with a covariance matrix adaptation evolution strategy (CMA-ES) to derive a set of values corresponding to different hyperparameters or other coefficients that, in combination, are used to derive an output given a sample input. For this set of values, a set of weights may be derived through random search, grid search, Bayesian optimization, or other hyperparameter optimization mechanism to fine-tune the hyperparameters of the generalized autonomous intelligent agent 102.

The initial training of the generalized autonomous intelligent agent 102 may be performed using human-in-the-loop (HITL) training techniques. For instance, the generalized autonomous intelligent agent 102 may be dynamically trained using a dataset comprising a large corpus of sample prompts and other data (e.g., historical prompts and data, hypothetical prompts and data, combinations of historical and hypothetical prompts and data, etc.), sample embeddings corresponding to the sample prompts and other data, and sample responses to the sample prompts and other data (e.g., historical responses, hypothetical responses, combinations of historical and hypothetical responses, etc.). The generalized autonomous intelligent agent 102 may process the sample prompts and data included in the dataset to generate a set of outputs (e.g., responses or other data outputs) corresponding to these sample prompts and other data. Through HITL, an evaluator may compare the set of outputs generated by the generalized autonomous intelligent agent 102 to the sample outputs from the dataset (i.e., expected outputs) to rank the generated outputs and provide corrections to these generated outputs, as necessary.

As illustrated in FIG. 1, the generalized autonomous intelligent agent 102 may leverage a set of domain-specific AI models 112 to generate responses to obtained user prompts and data from different devices and/or sensors 108 implemented in the user environment 110. The set of domain-specific AI models 112 is dynamically trained to provide responses and executable instructions for different devices and/or sensors 108 within the user environment 110 according to received prompts and data from the different devices and/or sensors 108 that are associated with specific knowledge domains. For instance, the generalized autonomous intelligent agent 102 may use one or more automated machine learning (AutoML) systems to generate a set of different domain-specific AI models that may be trained according to assigned domains and that incorporate different sources of knowledge associated with these domains (e.g., reference texts and manuals, domain-specific databases, training datasets, etc.). To generate this set of domain-specific AI models 112, the one or more AutoML systems may leverage various libraries that correspond to different types of machine learning models. For instance, the one or more AutoML systems may generate the set of domain-specific AI models 112 using recurrent neural networks (RNN), convoluted neural networks (CNN), long short-term memory (LSTM), k-means clustering algorithms, fuzzy c-means (FCM) algorithms, expectation-maximization (EM) algorithms, hierarchical clustering algorithms, density-based spatial clustering of applications with noise (DBSCAN) algorithms, genetic algorithms, backpropagation, reinforcement learning, decision trees, linear classification, anomaly detection, and the like. In an embodiment, each domain-specific AI model of the set of domain-specific AI models 112 is dynamically trained through knowledge distillation, wherein the generalized autonomous intelligent agent 102 can dynamically obtain different sources of knowledge associated with the particular domain for which the domain-specific AI model is to be implemented and transfers these sources of knowledge to the new domain-specific AI model. In some instances, each domain-specific AI model may be trained through Kolmogorov-Arnold networks (KAN) according to the Kolmogorov-Arnold representation theorem. Additionally, or alternatively, certain domain-specific AI models may be trained to form multilayer perceptrons (MLP). Thus, the set of domain-specific AI models 112 may include different domain-specific AI models that are dynamically trained and implemented according to knowledge distillation, KAN, and/or MLP configurations.

In an embodiment, the domain-specific AI models 112 can be implemented through the IoT device 104 and/or remote computing resources implemented within a remote computing environment. For instance, based on the computational and network resources associated with the IoT device 104, the generalized autonomous intelligent agent 102 may determine whether the domain-specific AI models 112 may be implemented through the IoT device 104 or through a remote computing environment. For example, when the generalized autonomous intelligent agent 102 identifies different knowledge domains for which domain-specific AI models 112 are to be generated, the generalized autonomous intelligent agent 102 may dynamically determine the resource requirements (e.g., processing requirements, memory requirements, storage requirements, etc.) associated with these domain-specific AI models 112. Based on these resource requirements and the known resources associated with the IoT device 104, the generalized autonomous intelligent agent 102 may dynamically determine whether to implement the domain-specific AI models 112 within the IoT device 104 or through a remote computing environment.

In an embodiment, the generalized autonomous intelligent agent 102 may further determine whether to implement the domain-specific AI models 112 within the IoT device 104 or through the remote computing environment based on other factors or requirements. For instance, the generalized autonomous intelligent agent 102 may automatically select a method for implementing the domain-specific AI models 112 according to cost considerations, whereby the generalized autonomous intelligent agent 102 may estimate the cost (e.g., energy costs, etc.) of processing user prompts and data from different devices and/or sensors 108 within the user environment 110 through the IoT device 104 and, based on this cost, determine whether to implement the domain-specific AI models 112 within the IoT device 104 or through a remote computing environment. As another illustrative example, based on the computational capabilities of the IoT device 104, the generalized autonomous intelligent agent 102 may estimate the latency that may be encountered when processing user prompts and data from different devices and/or sensors 108 through domain-specific AI models 112 implemented on the IoT device 104. If this estimated latency exceeds a pre-defined latency threshold for generating responses and executable instructions in response to user prompts and device/sensor data, the generalized autonomous intelligent agent 102 may determine that the domain-specific AI models 112 are to be implemented within the remote computing environment in order to minimize the amount of latency encountered during processing of user prompts and/or data associated with the different devices and/or sensors within the user environment 110.

In an embodiment, the set of domain-specific AI models 112 is organized according to different clusters or committees that correspond to specific domains or other areas of influence. For instance, the generalized autonomous intelligent agent 102 may define a cluster or committee of domain-specific AI models 112 that, collectively, can process prompts or requests corresponding to aircraft design, incorporating domain-specific AI models corresponding to aerodynamic principles, structural analysis, propulsion and thermal analysis, control systems, and the like. As another illustrative example, the generalized autonomous intelligent agent 102 may define a cluster or committee of domain-specific AI models 112 that, collectively, can process prompts or requests corresponding to foreign policy, incorporating domain-specific AI models corresponding to world history, political theory, military doctrines, and the like. To maintain these different clusters or committees, the generalized autonomous intelligent agent 102 may assign specific keywords or disciplines to the different clusters or committees in order to maintain a clear division of labor amongst the different domain-specific AI models 112 implemented by the generalized autonomous intelligent agent 102. Each domain-specific AI model assigned to a particular cluster or committee may be associated with the specific keywords or disciplines such that, when the generalized autonomous intelligent agent 102 selects the particular cluster or committee to review a given prompt and generate a response to the prompt, the prompt may be provided to each of the domain-specific AI models 112 assigned to the cluster or committee.

To train a domain-specific AI model, the generalized autonomous intelligent agent 102 may use fuzzy logic, along with particle swarm optimization (PSO) and CMA-ES with reinforcement learning, for a particular subdiscipline assigned to the model. In some instances, the generalized autonomous intelligent agent 102 may apply a curriculum learning method according to any sources of knowledge associated with the subdiscipline for which the domain-specific AI model is being trained. For instance, using an initial dataset including sample prompts and expected outputs associated with a particular subdiscipline, the generalized autonomous intelligent agent 102 may evaluate the outputs generated by the domain-specific AI model to determine whether these outputs comport with the expected outputs defined in the dataset. If the generated outputs comport with the expected outputs, the generalized autonomous intelligent agent 102 may dynamically adjust the curriculum (i.e., dataset) to incorporate additional subdiscipline resources that may be more complex in nature and involve advanced concepts related to the subdiscipline. The domain-specific AI model may be evaluated against this new dataset to further enhance the capabilities of the domain-specific AI model in processing prompts related to its subdiscipline.

Application of the curriculum learning method, in an embodiment, includes obtaining myriad training materials from different external data sources 114 for training of the domain-specific AI models 112. For instance, the generalized autonomous intelligent agent 102 may aggregate data from various external data sources 114, including text-based reference materials, audiovisual recordings, images, news articles, scholarly journals, etc. from diverse domains and sources. Further, the generalized autonomous intelligent agent 102 may utilize web scraping, application programming interfaces (APIs), and any accessible datasets (public and/or private) to obtain additional data that may be used to train the domain-specific AI models 112 according to their assigned domains. The generalized autonomous intelligent agent 102 may convert the obtained data into corresponding reference embeddings that may be incorporated into the initial datasets used to train the domain-specific AI models 112. If the generated outputs comport with the expected outputs, the generalized autonomous intelligent agent 102 may dynamically adjust the curriculum (i.e., dataset) to incorporate additional reference embeddings corresponding to more advanced reference materials from the external data sources. The domain-specific AI model may be evaluated against this new dataset, as described above, to further enhance the domain-specific AI model.

In an embodiment, the generalized autonomous intelligent agent 102 is further trained to identify, based on an evaluation of a received user prompt or data from one or more devices and/or sensors within the user environment 110, a cluster or committee of domain-specific AI models to which a response may be solicited. For instance, the generalized autonomous intelligent agent 102 may be trained to employ natural language processing (NLP) techniques (including named entity recognition (NER) and dependency parsing) for converting received user prompts and device/sensor data into sets of prompt embeddings that may be used to identify the appropriate cluster or committee of domain-specific AI models that may be leveraged to generate a response to the prompt or device/sensor data. For instance, the generalized autonomous intelligent agent 102 may be dynamically trained using a dataset of sample inputs (e.g., prompts, device/sensor data, etc.) and sample embeddings corresponding to these sample inputs. Using fuzzy logic with CMA-ES, the generalized autonomous intelligent agent 102 may be initialized using a set of coefficients or hyperparameters. The generalized autonomous intelligent agent 102 may process the dataset of sample inputs and corresponding embeddings to generate an output. This output may specify, for each sample input included in the dataset, a predicted set of embeddings. This output may be compared to the sample embeddings defined in the dataset for each of the data points (e.g., sample prompts) to identify any inaccuracies or other errors.

If the output of the generalized autonomous intelligent agent 102 does not satisfy one or more criteria, one or more coefficients or hyperparameters of the generalized autonomous intelligent agent 102 may be iteratively updated to generate a new iteration of the generalized autonomous intelligent agent 102. This new iteration of the generalized autonomous intelligent agent 102 may be used to process the aforementioned training dataset, as well as any additional data points or other datasets to generate a new output for each data point in the training dataset. In some instances, an optimization algorithm may be used to iteratively update the one or more coefficients of the set of coefficients associated with the generalized autonomous intelligent agent 102. The new outputs generated by the generalized autonomous intelligent agent 102 may be evaluated to determine whether the new outputs satisfy the one or more criteria. This process of updating the set of coefficients associated with the generalized autonomous intelligent agent 102 according to the one or more criteria may be performed iteratively until an iteration of the generalized autonomous intelligent agent 102 is produced that satisfies the one or more criteria.

Once the generalized autonomous intelligent agent 102 is dynamically trained to convert received different inputs (e.g., user prompts, device/sensor data, etc.) into different sets of embeddings using NLP techniques and to use these sets of embeddings to identify which cluster or committee of domain-specific AI models may be leveraged to generate responses to these inputs, the generalized autonomous intelligent agent 102 may be integrated through the IoT device 104 to allows users within the user environment 110 (such as user 106) to begin submitting new prompts. Through the IoT device 104, a user 106 may submit their prompt for, or otherwise interact with, the generalized autonomous intelligent agent 102.

In an embodiment, the generalized autonomous intelligent agent 102 maintains a world knowledge graph representation of the different clusters or committees of domain-specific AI models that may be leveraged to generate responses to received inputs (e.g., user prompts, data from different devices and/or sensors 108 within the user environment 110, etc.). This world knowledge graph may be implemented through a data structure that represents the different domain-specific AI models 112 as individual nodes and any corresponding relationships using edges. The world knowledge graph may further denote the different knowledge domains or other areas of influence associated with each of these individual nodes, which may be used to define the different clusters or committees of domain-specific AI models implemented by the generalized autonomous intelligent agent 102. The world knowledge graph, in an embodiment, is further propagated to the individual domain-specific AI models 112 to enhance cross-domain knowledge sharing and emergent behavior as new inputs are processed. In an embodiment, the world knowledge graph is implemented at a central processing unit (CPU) layer of the IoT device 104 or other computer system that implements the generalized autonomous intelligent agent 102. This may allow for efficient identification a cluster or committee of domain-specific AI models that may be leveraged for generation of one or more responses to a user prompt. By maintaining the world knowledge graph at the CPU layer of the generalized autonomous intelligent agent system, other computational resources of the IoT device 104 or other computer system that implements the generalized autonomous intelligent agent 102 (such as graphics processing units (GPUs), tensor processing units (TPUs), neural processing units (NPUs), language processing units (LPUs), etc.) may be reserved for more extensive tasks, including the training of the generalized autonomous intelligent agent 102, the processing of any inputs according to an identified domain, the generation of responses to these inputs, and any other computationally intensive operation described herein.

In an embodiment, the IoT device 104 is a standalone computing device that is configured to further interact with the different devices and sensors 108 within the user environment 110 through corresponding communications channels to obtain and process data within the user environment 110. For example, the IoT device 104 may connected to one or more other IoT devices within the user environment 110. These connections may be established according to one or more IoT protocols. Example IoT protocols that may be implemented to facilitate the connections between the myriad IoT devices within the user environment 110 and the IoT device 104 may include, but are not limited to, the Advanced Message Queuing Protocol (AMQP), Bluetooth®, Bluetooth® Low Energy (BLE), Matter, the Constrained Application Protocol (CoAP), the Data Distribution Service (DDS) protocol, LoRaWAN, Lightweight Machine-to-Machine (LWM2M) protocol, Message Queuing Telemetry Transport (MQTT), Wi-Fi, HTTP/HTTPS, websockets, and the like. IoT devices that may be implemented in a user environment 110 may include, but are not limited to, home security devices (e.g., doorbell cameras, smart locks, alarm systems, etc.), home appliances (e.g., smart refrigerators, smart lights, smart televisions, smart speakers, smart washers and dryers, etc.), data streaming devices (e.g., audio, video, etc.), embedded devices (e.g., pacemakers, subcutaneous sensors, etc.), devices both wired and wireless (e.g., glucose monitors, glucose pumps, etc.), imaging sensors (e.g., passive infrared (PIR) sensors, ultrasound sensors, infrared sensors, environmental sensors, etc.), and the like.

The IoT device 104 may additionally be connected to one or more sensors within the user environment 110 and through which the generalized autonomous intelligent agent 102 implemented on the IoT device 104 may dynamically obtain device and sensor data. These one or more sensors may include, but are not limited to, home temperature sensors, air quality sensors, water monitoring sensors (e.g., leak detectors, water quality sensors, etc.), motion sensors, light sensors, door and window sensors, and the like. The one or more sensors may be connected to the IoT device 104 through one or more communications protocols, including any of the IoT protocols described above or other available communications protocols. Additionally, these one or more sensors may include audial sensors, ultrasound sensors, mmWave sensors, presence sensors, and the like. In some instances, the one or more sensors may be implemented on one or more of the IoT devices described above (e.g., a light sensor implemented on a smart television to determine a desired television brightness, a door sensor implemented on a smart refrigerator for detecting when the smart refrigerator is accessed, an air quality sensor implemented on a smart air conditioning/heating system, etc.). Thus, in some instances, the data obtained from one or more sensors may be included within the data obtained from one or more IoT devices. In some instances, the data from one or more sensors may be provided through standalone communications channels established between the IoT device 104 and these one or more sensors.

In an embodiment, in response to a user prompt received through the IoT device 104, the generalized autonomous intelligent agent 102 may process the user prompt using NLP techniques (such as those described above) to convert the user prompt into a set of prompt embeddings. As noted above, to maintain different clusters or committees of domain-specific AI models corresponding to different knowledge domains, the generalized autonomous intelligent agent 102 may assign specific keywords or disciplines to the different clusters or committees in order to maintain a clear division of labor amongst the different domain-specific AI models 112 implemented by the generalized autonomous intelligent agent 102. The generalized autonomous intelligent agent 102 may compare the set of prompt embeddings to these specific keywords or disciplines to identify the appropriate cluster or committee of domain-specific AI models that may be leveraged to generate a response to the user prompt.

In an embodiment, the set of domain specific AI models 112 and the specialized agents are implemented using computing resources that may be scalable on demand, whereby additional resources may be dynamically implemented in the event of greater resource demand (e.g., data spikes, more stringent bandwidth requirements to limit latency, etc.). In an embodiment, the generalized autonomous intelligent agent 102 dynamically monitors resource utilization of each of the domain specific AI models 112 to determine whether additional domain specific AI model instances are required for generating responses to different prompts. For instance, if the generalized autonomous intelligent agent 102 determines that a particular domain-specific AI model is failing to satisfy certain performance requirements (e.g., the model is unable to return responses within a threshold period of time, the model is experiencing an input load that exceeds a load threshold, the resources used to implement the model are inoperative or otherwise unavailable for execution of the model, etc.), the generalized autonomous intelligent agent 102 may dynamically provision additional computing resources for instantiation of a new domain-specific AI model that may supplement or replace the particular domain-specific AI model. This new domain-specific AI model may be automatically added to the cluster or committee of domain-specific AI models that the original domain-specific AI model was a member of.

In an embodiment, each cluster or committee of domain-specific AI models can include additional instances of the different domain-specific AI models that comprise the cluster or committee. These additional instances of the different domain-specific AI models may provide redundancy in the event that a particular domain-specific AI model is unable to process new prompts (e.g., the model is failing particular latency thresholds, the model is inoperative or otherwise unavailable, the model is experiencing a spike in demand, etc.). In an embodiment, upon identifying the appropriate cluster or committee of domain-specific AI models that may be leveraged to generate a response to the user prompt, the generalized autonomous intelligent agent 102 may dynamically evaluate the performance of each of the domain-specific AI models that comprise the cluster or committee to identify the particular set of domain-specific AI models to be used for processing the user prompt. This may include selection of particular instances of the different domain-specific AI models according to different performance metrics associated with these instances (e.g., latency, input load, memory utilization, processor utilization, etc.). Based on this evaluation, the generalized autonomous intelligent agent 102 may select the different domain-specific AI model instances within the cluster or committee that may be leveraged for processing of the user prompt.

In some instances, the generalized autonomous intelligent agent 102 may further process the user prompt to determine whether additional data from the user environment 110 is required for processing of the user prompt. For example, if the user 106 submits a user prompt requesting a change to the humidity and temperature within the user environment 110, the generalized autonomous intelligent agent 102 may automatically determine that humidity and temperature data within the user environment 110 is required for processing this user prompt. Accordingly, the generalized autonomous intelligent agent 102 may dynamically interact with one or more devices and/or sensors 108 within the user environment 110 (such as a smart thermostat and smart humidifier implemented in the user environment 110) to obtain the requisite data. This data may be used to supplement the user prompt.

In an embodiment, the generalized autonomous intelligent agent 102 is implemented using the learning intelligent distribution agent (LIDA) architecture, which is used to process myriad outputs from different domain-specific AI models 112 to generate responses to user prompts and/or data from different devices/sensors 108 within the user environment 110. The generalized autonomous intelligent agent 102, in an embodiment, implements one or more special-purpose modules that may evaluate any responses generated by the one or more domain-specific AI models associated with the selected cluster or committee to generate a comprehensive response to the inputs (e.g., user prompts and/or device/sensor data). For instance, if two or more domain-specific AI models produce conflicting responses to a given input, the generalized autonomous intelligent agent 102, through the one or more special-purpose modules implemented through the LIDA architecture, may dynamically weigh each response according to the intent expressed by the user 106 in their user prompt or as otherwise determined based on obtained data (i.e., device/sensor data) and the particular knowledge domains of the domain-specific AI models submitting proposed responses.

The execution of the different domain-specific AI models 112 of a particular cluster or committee may be performed in parallel such that each domain-specific AI model may simultaneously process a provided input (e.g., user prompt and/or device/sensor data) according to its corresponding knowledge domain. The outputs from each of these domain-specific AI models 112 may be circulated within the cluster or committee according to the world knowledge graph to further refine these outputs and/or leverage these outputs to converge towards a finalized response to the provided input. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains. Each domain-specific AI model may also monitor the performance of any downstream domain-specific AI model instances to select the appropriate domain-specific AI model instances to which an output may be provided for further processing.

When the generalized autonomous intelligent agent 102 obtains a response from the set of domain-specific AI models 112 associated with the selected cluster or committee, the generalized autonomous intelligent agent 102 may evaluate the response to determine whether the response may be provided to the user 106 and/or one or more devices/sensors 108 within the user environment 110. In an embodiment, using the LIDA architecture, the generalized autonomous intelligent agent 102 may process the outputs from the different domain-specific AI models 112 to generate a cohesive response to the provided input. The generalized autonomous intelligent agent 102, for instance, may dynamically weigh each response according to the intent expressed by the user 106 or otherwise determined from obtained device/sensor data and the particular knowledge domains of the domain-specific AI models submitting proposed responses. For example, if two or more domain-specific AI models produce conflicting responses for a given intent, the generalized autonomous intelligent agent 102, through the one or more special-purpose modules implemented through the LIDA architecture, may dynamically weigh each response according to the intent and the particular knowledge domains of the domain-specific AI models submitting proposed responses.

Once the generalized autonomous intelligent agent 102 has finalized a response for delivery to the user 106 and/or one or more devices and/or sensors 108 within the user environment 110, the generalized autonomous intelligent agent 102 may communicate the response to the user 106 and/or the one or more devices and/or sensors 108, such as through the IoT device 104. For instance, if the response is being provided in response to a user prompt received through the IoT device 104, the generalized autonomous intelligent agent 102 may communicate the response to the user 106 through one or more peripheral devices and/or interfaces of the IoT device 104. For example, if the IoT device 104 is a smart speaker that includes one or more audial output devices, the generalized autonomous intelligent agent 102 may convert the response into an audial output that may be communicated to the user 106 through the one or more audial output devices. As another illustrative example, if the IoT device 104 includes one or more display elements through which a graphical user interface (GUI) is provided, the generalized autonomous intelligent agent 102 may present the response to the user 106 through this GUI.

In an embodiment, if the response includes a set of executable instructions that are to be executed by one or more devices and/or sensors 108 within the user environment 110 in order to address an expressed intent (as determined based on a submitted user prompt and/or automatically from data obtained from different devices and/or sensors 108 in the user environment 110), the generalized autonomous intelligent agent 102 may automatically transmit these executable instructions to the one or more devices and/or sensors 108 according to the communications protocols implemented between the IoT device 104 and these one or more devices and/or sensors 108. In response to receiving these executable instructions, the one or more devices and/or sensors 108 may automatically execute these executable instructions to perform a desired operation. This operation may be identified by the set of domain-specific AI models 112 based on their processing of the provided inputs (e.g., user prompt and/or device/sensor data) according to their respective knowledge domains.

In an embodiment, the generalized autonomous intelligent agent 102 monitors subsequent user communications and data from the devices and sensors 108 in the user environment 110 to obtain feedback with regard to the provided response. The generalized autonomous intelligent agent 102 may continuously execute continuous reinforcement learning (CRL) using feature map attention loss (FMAL) to further reinforce and/or update the generalized autonomous intelligent agent 102 and the domain-specific AI models 112. For instance, as users and different devices and sensors 108 provide feedback with regard to provided responses, the generalized autonomous intelligent agent 102 may determine whether these responses successfully addressed the corresponding intents. For instance, if a user indicates that a response is unsatisfactory (e.g., the response was incorrect, the response did not comport with the user’s expectations, the response was not responsive to the user prompt, etc.), the generalized autonomous intelligent agent 102 may evaluate this feedback to determine the areas of improvement that should be addressed to improve response accuracy. Similarly, if the generalized autonomous intelligent agent 102 obtains new data from the devices and sensors 108 within the user environment 110 and determines that the previously expressed intent was not addressed, the generalized autonomous intelligent agent 102 may use this new data as feedback that may be used to determine the areas of improvement that should be addressed to better resolve the expressed intent. In an embodiment, if the generalized autonomous intelligent agent 102 determines that a particular domain-based AI model has provided an erroneous response according to its domain or area of influence, the generalized autonomous intelligent agent 102 can determine the source of this error and apply the aforementioned curriculum learning method to further train the domain-specific AI model according to its assigned knowledge domain. This process may include identifying additional external data sources 114 from which to obtain additional training materials and enhancing the training dataset used to train the domain-specific AI model by incorporating these additional training materials.

In an embodiment, the generalized autonomous intelligent agent 102 further implements a self-assessment and improvement loop (SAIL) or other feedback loop whereby the generalized autonomous intelligent agent 102 may automatically evaluate its performance, identifies areas for improvement, and autonomously applies updates to improve its performance. For instance, using SAIL, the generalized autonomous intelligent agent 102 may evaluate feedback to provided responses and accordingly annotate these responses in order to refine its capabilities in processing user prompts and data from different devices and sensors 108, and evaluating responses prior to dissemination to users and devices/sensors 108 over time. For instance, as feedback is obtained from myriad users and devices/sensors 108 over time, the generalized autonomous intelligent agent 102 may identify a need for new domain-specific AI models associated with new knowledge domains, as these new domain-specific AI models may be required to address changing contexts. Accordingly, using SAIL, the generalized autonomous intelligent agent 102 may access the external data sources 114 to obtain additional reference materials (such as those described above) according to the identified knowledge domains to implement and dynamically train these new domain-specific AI models. Thus, as the generalized autonomous intelligent agent 102 and the domain-specific AI models 112 process different user prompts associated with different users and data from different devices and sensors 108 within the user environment 110, the generalized autonomous intelligent agent 102 may dynamically retrain and/or reinforce itself and the domain-specific AI models 112 through the aforementioned methodologies.

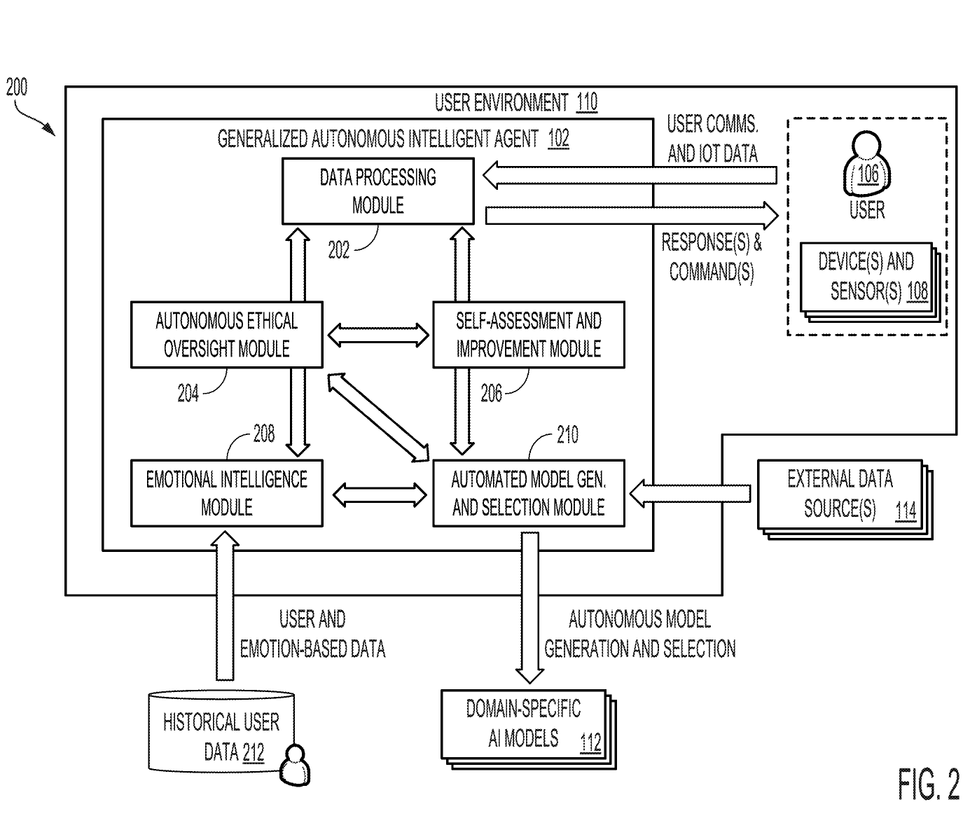

FIG. 2 shows an illustrative example of an environment 200 in which a generalized autonomous intelligent agent 102, through a set of specialized modules implemented on an IoT device, provides tailored responses to a user 106 and executable instructions for other devices and sensors 108 within a user environment 110 according to specific knowledge domains in accordance with at least one embodiment. In the environment 200, the generalized autonomous intelligent agent 102 may include a data processing module 202 that is configured to process user prompts and other data from different devices and sensors 108 within the user environment 110 in order to adapt the communication style of the generalized autonomous intelligent agent 102 according to a user’s detected emotional state. For instance, in response to a user prompt, the data processing module 202 may transmit the user prompt to an emotional intelligence module 208 that is trained to determine the emotional state of the user 106 and, accordingly, tailor responses to the user prompt that comport with the user’s emotional state at any given time or that otherwise comport with the user’s identified idiosyncrasies. Similarly, in response to obtaining data from one or more devices and/or sensors 108, the data processing module 202 may leverage the emotional intelligence module 208 to incorporate the user’s identified idiosyncrasies into responses provided to the user 106 based on the data obtained from the one or more devices and/or sensors 108.

In an embodiment, the emotional intelligence module 208 implements a personal identity network (PIN) algorithm that is trained to construct a coherent narrative from filtered experiences associated with the user 106 over time. Filtered experiences associated with a user 106 may be maintained and stored in a historical user datastore 212 based on historical communications sessions between the user 106 and the generalized autonomous intelligent agent 102 over time. For instance, when the user 106 engages the generalized autonomous intelligent agent 102 to obtain responses to user prompts, the data processing module 202 may automatically record any exchanged communications within the historical user datastore 212. The historical user datastore 212 may include, for each user of the generalized autonomous intelligent agent 102, an entry corresponding to the user and within which the data processing module 202 may store the communications exchanged between the user and the generalized autonomous intelligent agent 102. If the user 106 is accessing the generalized autonomous intelligent agent 102 for the first time, the data processing module 202 may generate a new entry associated with the user within the historical user datastore 212.

In order to construct a personal history and emotional model for a particular user 106, the emotional intelligence module 208 may use the PIN algorithm to perform narrative segmentation of communications exchanged between the user 106 and the generalized autonomous intelligent agent 102 by dividing these communications into different segments according to detected themes, events, goals, and the like. Further, the PIN algorithm may organize these different segments into a chronological structure while highlighting key developments and achievements. The PIN algorithm may assign weights to each of these segments based on emotional significance such that user prompts identified as having greater emotional significance to the user 106 may be given greater emphasis and addressed. Further, through the PIN algorithm, the emotional intelligence module 208 may generate a user profile that may be used to define an emotion-based response strategy (i.e., tailored personality) for responding to user prompts and for providing communications in response to data from different devices and sensors 108 implemented in the user environment 110. For instance, the data processing module 202 may leverage this user profile to tailor its responses according to any detected user idiosyncrasies, linguistic patterns, dialects, and the like, thereby increasing the likelihood of the user 106 being comfortable communicating with the generalized autonomous intelligent agent 102 over time. In some instances, the emotional intelligence module 208 may periodically analyze the user profile and corresponding narrative segmentation and structuring to identify any patterns, biases, or areas for improvement in agent performance. Through this analysis, the emotional intelligence module 208 may update the user profile associated with the user 106 and enable the data processing module 202 to improve its tailoring of responses according to any updated user characteristics.

In an embodiment, in response a newly received user prompt, the data processing module 202, using NLP techniques, can process the newly received user prompt to identify any expressed keywords, phrases, or other terms that may be indicative of the user’s expressed intent. The data processing module 202 may transmit these identified keywords, phrases, or other terms to the emotional intelligence module 208, which may process these identified keywords, phrases, or other terms to determine the user’s current sentiment or emotional state. In an embodiment, the emotional intelligence module 208 is further trained to process other inputs to determine the user’s current sentiment or emotional state. For example, the generalized autonomous intelligent agent 102, through the IoT device and/or the different devices and sensors 108, may allow the user to engage with the generalized autonomous intelligent agent 102 using real-time audiovisual communications. In an embodiment, the emotional intelligence module 208 uses computer vision or other machine learning algorithm/artificial intelligence techniques to dynamically, and in real-time, process the real-time audiovisual communications associated with the user 106 to determine the user’s current sentiment or emotional state. For instance, using computer vision or other machine learning algorithm/artificial intelligence techniques, the emotional intelligence module 208 may generate a data representation (e.g., vectors, tensors, etc.) with values representing the user 106. This data representation of the user 106 may correspond to any detected user mannerisms, eye movements, pupil dilation, body language, and the like.

In an embodiment, the emotional intelligence module 208, using computer vision or other machine learning algorithm/artificial intelligence techniques, generates a baseline data representation of the user 106. This baseline data representation of the user 106may denote a neutral emotional state or sentiment that represents the user’s natural communication cadence and other idiosyncrasies. Further, this baseline data representation of the user 106 may be reinforced using NLP techniques, which may be used to identify any expressed keywords, phrases, or other terms that may be indicative of the user’s expressed intent and current sentiment or emotional state. As the emotional intelligence module 208, using computer vision or other machine learning algorithm/artificial intelligence techniques, processes a data feed comprising audiovisual communications exchanged in real-time, the emotional intelligence module 208 may obtain new data representations of the user 106, with values representing the new biometric information associated with the user 106. The emotional intelligence module 208 may compare these new data representations of the user 106 to the baseline data representation of the user 106 to detect any differences that may denote changes in the user’s emotional state or sentiment. For instance, certain deviations from the baseline data representation may correspond to particular emotional states or sentiments, which may be corroborated or reinforced through evaluation of additional inputs (e.g., text-based inputs, etc.).

Based on the user’s current sentiment or emotional state, the emotional intelligence module 208 may evaluate the user profile corresponding to the user 106 and the historical data corresponding to prior user communications with the generalized autonomous intelligent agent 102 (as provided in the historical user datastore 212), to determine and tailor a response strategy that may be implemented by the data processing module 202 to generate a response to the user prompt that addresses the user’s current emotional state and that adapts to the user’s communication style and/or other idiosyncrasies. Further, based on this evaluation, the emotional intelligence module 208 may provide, to the data processing module 202, an indication as to whether the user prompt should be prioritized in order to address the user’s current emotional state. For instance, if the emotional intelligence module 208 detects that the user 106 has communicated a user prompt that denotes a sense of urgency in obtaining a response to the user prompt, the emotional intelligence module 208 may transmit an indication to the data processing module 202 that the particular user prompt should be prioritized in order to expedite providing a response to the user prompt.

In an embodiment, if the data processing module 202 obtains data from one or more devices and sensors 108 operating within the user environment 110 and that is indicative of a need to perform one or more operations within the user environment 110, the data processing module 202 may leverage the emotional intelligence module 208 to obtain a response strategy according to the user’s communication system and/or other idiosyncrasies. For instance, while this data may not include any user communications that may be used to determine the user’s present emotional state, the emotional intelligence module 208 may still process the user profile associated with the user 106 and the historical data corresponding to prior user communications with the generalized autonomous intelligent agent 102 (as provided in the historical user datastore 212), to determine and tailor a response strategy that may be implemented by the data processing module 202 for communicating with the user 106 with regard to the obtained data and any subsequent operations performed in response to this obtained data.

In some instances, the data processing module 202 may process a received user prompt to determine whether additional data from the user environment 110 is required for processing of the user prompt. Returning to an earlier illustrative example, if the user 106 submits a user prompt requesting a change to the humidity and temperature within the user environment 110, the data processing module 202 may automatically determine that humidity and temperature data within the user environment 110 are required for processing this user prompt. Accordingly, the data processing module 202 may dynamically interact with one or more devices and/or sensors 108 within the user environment 110 (such as a smart thermostat and smart humidifier implemented in the user environment 110) to obtain the requisite data. This data may be used to supplement the user prompt.

In an embodiment, in addition to determining the user’s emotional state and developing a response strategy that addresses the user’s emotional state, the data processing module 202, through an autonomous ethical oversight module 204, may evaluate the user prompt and/or obtained device/sensor data to determine whether providing a response may have ethical and/or moral implications. The autonomous ethical oversight module 204, in an embodiment, is implemented to evaluate user prompts and other data to ensure that these user prompts and other data comport with any applicable ethical rules or standards, ensuring that the generalized autonomous intelligent agent 102 and the domain-specific AI models 112 are not misused or otherwise do not cause unintended consequences. For example, the autonomous ethical oversight module 204 may implement a set of applicable ethical rules or standards that may specify what intents may be processed by the generalized autonomous intelligent agent 102 as well as any actions that may be performed in the event that a user submits an impermissible prompt. These ethical rules or standards may be specific to certain users or user characteristics. For instance, these ethical rules or standards may correspond to the location of the user 106 (e.g., the ethical rules or standards may correspond to local laws and regulations, etc.). As another example, these ethical rules or standards may correspond to a user’s organization (i.e., employer, etc.). In some instances, the ethical rules or standards may correspond to specific intents that may have questionable or harmful ethical and/or moral ramifications (e.g., self-harm, significant potential for harm to others, etc.).

In an embodiment, if the user 106 submits a user prompt to the generalized autonomous intelligent agent 102, the autonomous ethical oversight module 204 evaluates in real-time the received user prompt to determine whether the user prompt comports with applicable ethical rules and standards. For instance, the data processing module 202, using the aforementioned NLP techniques, may automatically parse the user prompt to identify particular terms and/or phrases that may denote an intent expressed by the user 106. The data processing module 202 may automatically transmit these identified terms and/or phrases to the autonomous ethical oversight module 204 to determine whether these identified terms and/or phrases and, hence, the user intent, comport with applicable ethical rules and standards. In an embodiment, the autonomous ethical oversight module 204 further evaluates in real-time any data obtained from different devices and/or sensors 108 within the user environment 110 to determine whether this data comports with applicable ethical rules and standards.

If the autonomous ethical oversight module 204 determines that the determined intent does not comport with the applicable ethical rules and standards, the autonomous ethical oversight module 204 may automatically determine what action may be taken as a result of the impermissible prompt. For instance, the autonomous ethical oversight module 204 may update the common user database implemented by the generalized autonomous intelligent agent 102 to suspend the user, limit the user’s interactions with the generalized autonomous intelligent agent 102, or otherwise perform any required disciplinary action. In some instances, the autonomous ethical oversight module 204 may communicate with external entities as required to address any violations of the applicable ethical rules and standards (e.g., law enforcement agencies, employers, etc.). In some instances, if the autonomous ethical oversight module 204 obtains data from a device that is not authorized to communicate with the generalized autonomous intelligent agent 102 (e.g., the device implements malware, spyware, or other unauthorized software/hardware, etc.), the autonomous ethical oversight module 204 may perform one or more remedial actions, such as terminating any communications sessions between the generalized autonomous intelligent agent 102 and this device.

In an embodiment, if the data processing module 202 determines, through the autonomous ethical oversight module 204, that the user prompt and/or provided data satisfy a corresponding set of applicable ethical rules and standards, the data processing module 202 may transmit the user prompt and/or the provided data to an automated model generation and selection module 210 to generate one or more responses to the user prompt or that otherwise correspond to the provided data. The automated model generation and selection module 210 may dynamically generate and maintain domain-specific AI models 112 that are dynamically trained to provide responses to provided inputs (e.g., user prompts, data from different devices and/or sensors 108, etc.) associated with specific knowledge distillation techniques. For instance, the automated model generation and selection module 210 implements one or more AutoML systems to generate different domain-specific AI models 112 corresponding to different knowledge domains and that are trained using different resources from external data sources 114. Through these external data sources 114, the automated model generation and selection module 210 may access different sources of knowledge to obtain reference texts and manuals, domain-specific databases, training datasets, etc. that may be used to dynamically train these one or more domain-specific AI models 112.

In an embodiment, when generating the different domain-specific AI models 112, the automated model generation and selection module 210 determines whether to implement the domain-specific AI models 112 within the IoT device that implements the generalized autonomous intelligent agent 102 or through the remote computing environment based on one or more factors and/or requirements. For instance, the automated model generation and selection module 210 may automatically select a method for implementing the domain-specific AI models 112 according to cost considerations, whereby the automated model generation and selection module 210 may estimate the cost (e.g., energy costs, etc.) of processing user prompts and data from different devices and/or sensors 108 within the user environment 110 through the IoT device and, based on this cost, determine whether to implement the domain-specific AI models 112 within the IoT device or through a remote computing environment. As another illustrative example, based on the computational capabilities of the IoT device, the automated model generation and selection module 210 may estimate the latency that may be encountered when processing user prompts and data from different devices and/or sensors 108 through domain-specific AI models 112 implemented on the IoT device. If this estimated latency exceeds a pre-defined latency threshold for generating responses and executable instructions in response to user prompts and device/sensor data, the automated model generation and selection module 210 may determine that the domain-specific AI models 112 are to be implemented within the remote computing environment in order to minimize the amount of latency encountered during processing of user prompts and/or data associated with the different devices and/or sensors within the user environment 110.

In an embodiment, to generate this set of domain-specific AI models 112, the automated model generation and selection module 210, through the one or more AutoML systems, may leverage various libraries that correspond to different types of machine learning models. For instance, the one or more AutoML systems may generate the set of domain-specific AI models 112 using RNNs, CNNs, LSTM, k-means clustering algorithms, FCM algorithms, EM algorithms, hierarchical clustering algorithms, DBSCAN algorithms, genetic algorithms, backpropagation, reinforcement learning, decision trees, linear classification, anomaly detection, and the like. As noted above, each domain-specific AI model of the set of domain-specific AI models 112 may be dynamically trained through knowledge distillation, KAN, and/or MLP. In an embodiment, if the automated model generation and selection module 210 determines that one or more domain-specific AI models are to be implemented through a remote computing environment, the automated model generation and selection module 210 may transmit a request to a generalized autonomous intelligent agent within the remote computing environment to implement these one or more domain-specific AI models. The automated model generation and selection module 210 may provide, to this other generalized autonomous intelligent agent, any configuration information associated with these one or more domain-specific AI models (e.g., knowledge domains associated with the one or more domain-specific AI models, cluster/committee assignments associated with the one or more domain-specific AI models, different resources from external data sources 114 for training of the one or more domain-specific AI models, etc.). This may allow the other generalized autonomous intelligent agent to dynamically train and implement these one or more domain-specific AI models within the remote computing environment and enable communication between the generalized autonomous intelligent agent 102 and these one or more domain-specific AI models.

The automated model generation and selection module 210 may organize the set of domain-specific AI models 112 according to different clusters or committees that correspond to specific knowledge domains or other areas of influence. To maintain these different clusters or committees, the automated model generation and selection module 210 may assign specific keywords or disciplines to the different clusters or committees in order to maintain a clear division of labor amongst the different domain-specific AI models 112. Each domain-specific AI model assigned to a particular cluster or committee may be associated with the specific keywords or disciplines such that, when the automated model generation and selection module 210 selects a particular cluster or committee to review a given input (i.e., user prompt and/or data from different devices and sensors 108) and generate a response to the given input, the input may be provided to each of the domain-specific AI models 112 assigned to the cluster or committee.

In an embodiment, for each domain-specific AI model, the automated model generation and selection module 210 uses fuzzy logic, along with PSO and CMA-ES with reinforcement learning, for a particular subdiscipline assigned to the model. In some instances, the automated model generation and selection module 210 may apply a curriculum learning method according to any sources of knowledge associated with the subdiscipline for which the domain-specific AI model is being trained. For instance, using an initial dataset including sample inputs and expected outputs associated with a particular subdiscipline, the automated model generation and selection module 210 may evaluate the outputs generated by the domain-specific AI model to determine whether these outputs comport with the expected outputs defined in the dataset. If the generated outputs comport with the expected outputs, the automated model generation and selection module 210 may dynamically adjust the curriculum to incorporate additional subdiscipline resources (such as from the external data sources 114) that may be more complex in nature and involve advanced concepts related to the subdiscipline. The domain-specific AI model may be evaluated against this new dataset to further enhance the capabilities of the domain-specific AI model in processing prompts related to its subdiscipline.

In an embodiment, the automated model generation and selection module 210 is trained to identify, based on an evaluation of a received input (as provided by the data processing module 202), the cluster or committee of domain-specific AI models 112 to which a response to the input (e.g., user prompt and/or data from one or more devices and sensors 108) may be solicited. For instance, the automated model generation and selection module 210 may be trained to employ NLP techniques (including NER and dependency parsing) for converting received user prompts into sets of prompt embeddings that may be used to identify the appropriate cluster or committee of domain-specific AI models 112 that may be leveraged to generate a response to the prompt. As another illustrative example, the automated model generation and selection module 210 may evaluate the obtained data from the one or more devices and sensors 108 to classify the data and, according to this classification, identify the appropriate cluster or committee of domain-specific AI models 112 that may be leveraged to evaluate the data and generate a response that comports with this data. Returning to an earlier example, where the data from the one or more devices and sensors 108 includes temperature and humidity data, the automated model generation and selection module 210 may process this data to determine that the data corresponds to a possible need to change the ambient characteristics of the user environment 110. Accordingly, based on this classification, the automated model generation and selection module 210 may select a cluster or committee of domain-specific AI models 112 that may process intents corresponding to ambient change requests.

As the automated model generation and selection module 210 trains and implements domain-specific AI models 112 and defines different clusters or committees according to different knowledge domains, the automated model generation and selection module 210 may generate a world knowledge graph representation of these different clusters or committees. If there is an existing world knowledge graph corresponding to previously generated clusters or committees, the automated model generation and selection module 210 may dynamically update the existing world knowledge graph to update the previously generated clusters/committees and/or define new clusters/committees according to the newly implemented domain-specific AI models 112 and associated knowledge domains. This world knowledge graph may be leveraged to determine, based on a provided input, which cluster or committee of domain-specific AI models may be solicited to provide responses to the provided input. As noted above, the world knowledge graph implemented by the automated model generation and selection module 210 may be implemented through a data structure that represents the different domain-specific AI models 112 as individual nodes and any corresponding relationships using edges. The world knowledge graph may further denote the different knowledge domains or other areas of influence associated with each of these individual nodes, which may be used to define the different clusters or committees of domain-specific AI models implemented by the generalized autonomous intelligent agent system. The world knowledge graph, in an embodiment, is further propagated to the individual domain-specific AI models 112 to enhance cross-domain knowledge sharing and emergent behavior as new user prompts are processed.

In response to a given input (i.e., a user prompt and/or data from one or more devices and sensors 108), the automated model generation and selection module 210 may convert the input into a set of input embeddings. The automated model generation and selection module 210 may compare the set of input embeddings to the specific keywords or disciplines assigned to each cluster or committee of domain-specific AI models to identify the appropriate cluster or committee of domain-specific AI models that may be leveraged to generate a response to the input. Once the automated model generation and selection module 210 has identified the appropriate cluster or committee of domain-specific AI models for processing of the input, the automated model generation and selection module 210 may transmit the input to each of the domain-specific AI models associated with the cluster or committee to solicit responses to the input. The different domain-specific AI models 112 within the cluster or committee may collaboratively process the provided input according to their individual knowledge domains to generate a cohesive and comprehensive response to the input. Further, each domain-specific AI model may review and refine any outputs generated by the different domain-specific AI models within a cluster or committee to ensure response accuracy.

As noted above, the execution of the different domain-specific AI models 112 of a particular cluster or committee may be performed in parallel such that each domain-specific AI model may simultaneously process a given input (i.e., a user prompt and/or data generated by one or more devices and sensors 108 within the user environment 110) according to its corresponding knowledge domain. The outputs from each of these domain-specific AI models may be circulated within the cluster or committee according to the world knowledge graph to further refine these outputs and/or leverage these outputs to converge towards a finalized response to the provided input. Further, the outputs may be evaluated according to the knowledge domains of the domain-specific AI models to identify any inaccuracies or fine-tuning requirements that may be addressed and used to refine these outputs. Any updates made to the outputs generated by the domain-specific AI models may be used to refine (e.g., retrain or reinforce) these domain-specific AI models according to their specific knowledge domains.

When the automated model generation and selection module 210 obtains a response from the set of domain-specific AI models 112 associated with the selected cluster or committee, the automated model generation and selection module 210 may evaluate the response to determine whether the response may be provided to the user 106 and/or one or more devices and sensors 108 implemented in the user environment 110. In an embodiment, the automated model generation and selection module 210 is implemented using the LIDA architecture, which is used to process the outputs from the different domain-specific AI models 112 to generate a cohesive response to the user prompt and/or data provided by the one or more devices and sensors 108. The automated model generation and selection module 210, for instance, may dynamically weigh each response according to the intent associated with the user prompt and/or data from the one or more devices and sensors 108, and the particular knowledge domains of the domain-specific AI models submitting proposed responses.

In an embodiment, prior to providing a response to a given input (i.e., user prompt and/or data from one or more devices and sensors 108), the automated model generation and selection module 210, through the autonomous ethical oversight module 204, evaluates the response to ensure that the response comports with any applicable ethical rules or standards, ensuring that the generalized autonomous intelligent agent 102 and the domain-specific AI models 112 are not misused or otherwise do not cause unintended consequences. For instance, the autonomous ethical oversight module 204 may perform emotion-informed risk assessment to consider emotional aspects when evaluating risks and potential outcomes from providing the generated response to the user 106. For instance, a given response may present possible ethical dilemmas whereby, based on the user profile, the autonomous ethical oversight module 204 may determine that providing the generated response could result in possible self-harm or other forms of harm (e.g., harm or violence to others, violation of applicable laws and regulations, violation of workplace policies, etc.). Accordingly, the autonomous ethical oversight module 204 may modify the response to remove any information or other data that may be problematic. Additionally, prior to providing a response, the automated model generation and selection module 210, through the emotional intelligence module 208, may modify the response according to the user’s previously identified emotional state and adapt the response according to the user’s communication style and/or other idiosyncrasies, as described above.

In some instances, if the response includes executable instructions that may be executed by one or more devices and/or sensors 108 within the user environment 110 to perform a desired operation, the autonomous ethical oversight module 204 may evaluate these executable instructions to determine whether their execution would result in unintended consequences for the user 106, the one or more devices and/or sensors 108, and the user environment 110 as a whole. For example, if execution of the executable instructions would result in one or more devices and/or sensors 108 operating beyond their capabilities, increasing potential risk to these one or more devices and/or sensors 108 and to the user 106, the autonomous ethical oversight module 204 may modify the executable instructions to ensure that execution of these modified executable instructions would not result in such undesired operation. As another illustrative example, if execution of the executable instructions would result in hazardous conditions for the user 106 within the user environment 110, the autonomous ethical oversight module 204 may dynamically modify these executable instructions to prevent the one or more devices and/or sensors 108 from creating these hazardous conditions.

Once the automated model generation and selection module 210 has finalized a response for delivery to the user 106 and/or one or more devices and/or sensors 108, the automated model generation and selection module 210 may provide this finalized response to the data processing module 202 for communication to the user 106 and/or one or more devices and/or sensors 108. In an embodiment, the data processing module 202 monitors subsequent communications among the user 106, the one or more devices and sensors 108, and the generalized autonomous intelligent agent 102 to obtain feedback with regard to provided response. The data processing module 202 may provide this feedback to a self-assessment and improvement module 206, which continuously executes CRL using FMAL to further reinforce and/or update the different modules 202-210 of the generalized autonomous intelligent agent 102 and the domain-specific AI models 112. Returning to an earlier example, as users and different devices and sensors 108 provide feedback with regard to provided responses, the self-assessment and improvement module 206 may determine whether these responses successfully addressed the corresponding intents. For instance, if a user indicates that a response is unsatisfactory (e.g., the response was incorrect, the response did not comport with the user’s expectations, the response was not responsive to the user prompt, etc.), the self-assessment and improvement module 206 may evaluate this feedback to determine the areas of improvement that should be addressed to improve response accuracy. Similarly, if the self-assessment and improvement module 206 obtains new data from the devices and sensors 108 within the user environment 110 and determines that the previously expressed intent was not addressed, the self-assessment and improvement module 206 may use this new data as feedback that may be used to determine the areas of improvement that should be addressed to better resolve the expressed intent.

In an embodiment, the self-assessment and improvement module 206 further implements SAIL or other feedback loop whereby the self-assessment and improvement module 206 may automatically evaluate the performance of the other modules of the generalized autonomous intelligent agent 102, identifies areas for improvement, and autonomously applies updates to improve the performance of these modules. For instance, using SAIL, the self-assessment and improvement module 206 may evaluate feedback corresponding to provided responses and accordingly annotate these responses in order to refine the capabilities of the different modules in processing different inputs (i.e., user prompts and/or data from different devices and sensors 108) and evaluating responses prior to dissemination to users and different devices and sensors 108 over time. For instance, as feedback is obtained from myriad users and devices/sensors 108 over time, the self-assessment and improvement module 206 may identify a need for new domain-specific AI models associated with new knowledge domains, as these new domain-specific AI models may be required to address changing contexts. Accordingly, using SAIL, the self-assessment and improvement module 206 may access the external data sources 114 to obtain additional reference materials (such as those described above) according to the identified knowledge domains to implement and dynamically train these new domain-specific AI models. Thus, as the generalized autonomous intelligent agent 102 and the domain-specific AI models 112 process different inputs associated with different users and different devices/sensors 108 within a user environment 110, the self-assessment and improvement module 206 may dynamically retrain and/or reinforce itself and the domain-specific AI models 112 through the aforementioned methodologies.

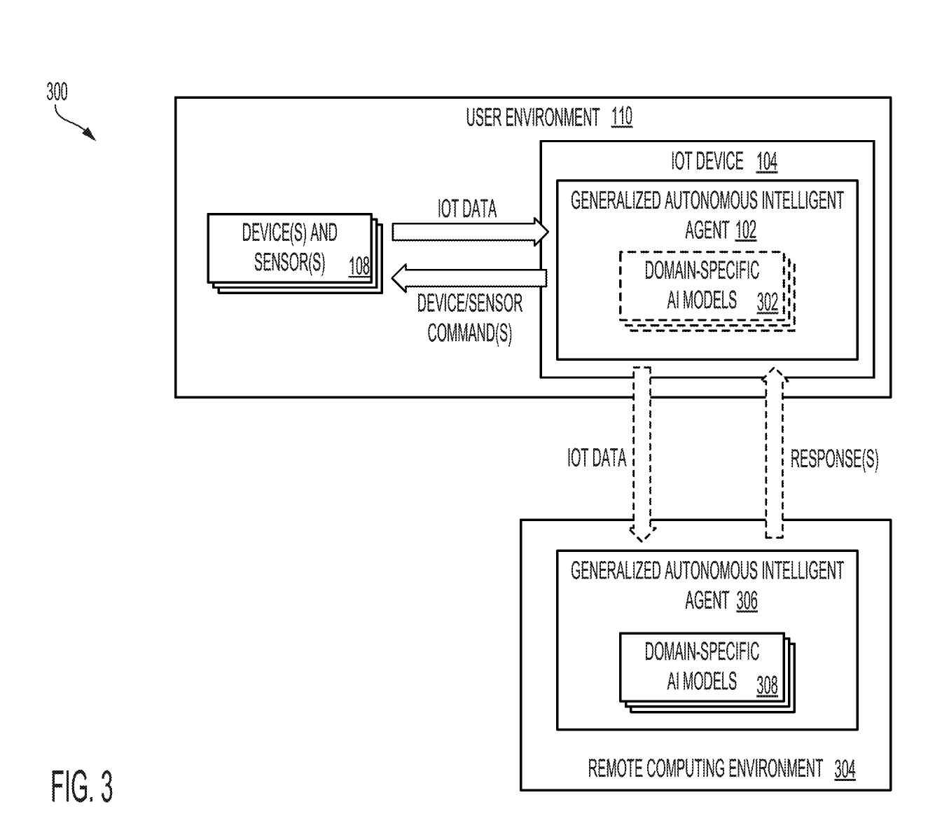

FIG. 3 shows an illustrative example of an environment 300 in which a generalized autonomous intelligent agent 102 implemented on an IoT device 104 within a user environment 110 dynamically transmits IoT data to another generalized autonomous intelligent agent 306 implemented in a remote computing environment 304 to obtain tailored responses and executable instructions in accordance with at least one embodiment. In the environment 300, a generalized autonomous intelligent agent 102 implemented through an IoT device 104 in a user environment 110 may dynamically obtain IoT data from one or more devices and sensors 108 implemented in the user environment 110. As noted above, the IoT device 104 may be connected to the one or more devices and sensors 108 within the user environment 110 through communications sessions established according to one or more IoT protocols and/or other communications protocols.

In an embodiment, the generalized autonomous intelligent agent 102 continuously receives IoT data from the different devices and sensors 108 in real-time as the IoT data is generated by these different devices and sensors 108. For instance, a smart thermostat operating within the user environment 110 may continuously transmit temperature data to the IoT device 104 to indicate the present temperature within the user environment 110. As another illustrative example, a light sensor may continuously transmit data corresponding to the operating status of a corresponding light fixture within the user environment 110, as well as data corresponding to the light levels within one or more rooms within the user environment 110.

As the generalized autonomous intelligent agent 102 receives IoT data from the different devices and sensors 108 in the user environment 110, the generalized autonomous intelligent agent 102 may dynamically process this IoT data to determine whether this IoT data is indicative of a need to perform one or more operations within the user environment 110. For instance, if the generalized autonomous intelligent agent 102 determines, based on obtained IoT data, that the ambient temperature within the user environment 110 is dropping due to the failure of one or more components of a furnace, the generalized autonomous intelligent agent 102 may determine that one or more operations need to be identified in order to address this issue. Further, if this drop in ambient temperature could result in other ancillary effects (e.g., damage to other devices/sensors within the user environment 110, harm to one or more users within the user environment 110, etc.), the generalized autonomous intelligent agent 102 may further determine that additional operations may be required to prevent or otherwise mitigate these ancillary effects. In some instances, the generalized autonomous intelligent agent 102 may annotate this IoT data to indicate this need to perform one or more operations to address the identified issues.

As noted above, the generalized autonomous intelligent agent 102 may leverage a set of domain-specific AI models to generate responses to IoT data from different devices and/or sensors 108 implemented in the user environment 110. These domain-specific AI models may be implemented through the IoT device 104 (e.g., domain-specific AI models 302) and/or remote computing resources (e.g., domain-specific AI models 308) implemented within a remote computing environment 304. For instance, based on the computational and network resources associated with the IoT device 104, the generalized autonomous intelligent agent 102 may determine whether different domain-specific AI models may be implemented through the IoT device 104 or through a remote computing environment 304. For example, when the generalized autonomous intelligent agent 102 identifies different knowledge domains for which domain-specific AI models are to be generated, the generalized autonomous intelligent agent 102 may dynamically determine the resource requirements (e.g., processing requirements, memory requirements, storage requirements, etc.) associated with these domain-specific AI models. Based on these resource requirements and the known resources associated with the IoT device 104, the generalized autonomous intelligent agent 102 may dynamically determine whether to implement the domain-specific AI models within the IoT device 104 or through a remote computing environment 304.

The generalized autonomous intelligent agent 102 may further determine whether to implement the domain-specific AI models within the IoT device 104 or through the remote computing environment 304 based on other factors or requirements. For instance, the generalized autonomous intelligent agent 102 may automatically select a method for implementing the domain-specific AI models according to cost considerations, whereby the generalized autonomous intelligent agent 102 may estimate the cost (e.g., energy costs, etc.) of processing user prompts and data from different devices and/or sensors 108 within the user environment 110 through the IoT device 104 and, based on this cost, determine whether to implement the domain-specific AI models within the IoT device 104 or through a remote computing environment 304. As another illustrative example, based on the computational capabilities of the IoT device 104, the generalized autonomous intelligent agent 102 may estimate the latency that may be encountered when processing user prompts and data from different devices and/or sensors 108 through domain-specific AI models implemented on the IoT device 104. If this estimated latency exceeds a pre-defined latency threshold for generating responses and executable instructions in response to user prompts and device/sensor data, the generalized autonomous intelligent agent 102 may determine that the domain-specific AI models are to be implemented within the remote computing environment 304 in order to minimize the amount of latency encountered during processing of user prompts and/or data associated with the different devices and/or sensors within the user environment 110.

If the generalized autonomous intelligent agent 102 determines that one or more domain-specific AI models 308 are to be implemented within the remote computing environment 304, the generalized autonomous intelligent agent 102 may transmit a request to a generalized autonomous intelligent agent 306 within the remote computing environment 304 to implement these one or more domain-specific AI models 308. The generalized autonomous intelligent agent 102 may provide, to this other generalized autonomous intelligent agent 306, any configuration information associated with these one or more domain-specific AI models 308 (e.g., knowledge domains associated with the one or more domain-specific AI models, cluster/committee assignments associated with the one or more domain-specific AI models, different resources from external data sources 114 for training of the one or more domain-specific AI models, etc.). This may allow the other generalized autonomous intelligent agent 306 to dynamically train and implement these one or more domain-specific AI models 308 within the remote computing environment 304 and enable communication between the generalized autonomous intelligent agent 102 and these one or more domain-specific AI models 308.

In an embodiment, the domain-specific AI models 302 and the domain-specific AI models 308 are organized according to different clusters or committees that correspond to specific domains or other areas of influence. To maintain these different clusters or committees, the generalized autonomous intelligent agent 102 may assign specific keywords or disciplines to the different clusters or committees in order to maintain a clear division of labor amongst the different domain-specific AI models implemented by the generalized autonomous intelligent agent 102 and the generalized autonomous intelligent agent 306. Each domain-specific AI model assigned to a particular cluster or committee may be associated with the specific keywords or disciplines such that, when the generalized autonomous intelligent agent 102 selects the particular cluster or committee to review a given input and generate a response to the given input, the input may be provided to each of the domain-specific AI models assigned to the cluster or committee.

In some instances, a cluster or committee may include different domain-specific AI models implemented by the IoT device 104 and/or within the remote computing environment 304. For instance, if the generalized autonomous intelligent agent 102, based on obtained IoT data, identifies a particular domain-specific AI model cluster or committee comprising one or more domain-specific AI models implemented on the IoT device 104 and one or more domain-specific AI models implemented by the other generalized autonomous intelligent agent 306 within the remote computing environment 304, the generalized autonomous intelligent agent 102 may provide the IoT data to the one or more domain-specific AI models implemented on the IoT device 104 and to the generalized autonomous intelligent agent 306 for dissemination of the IoT data to the one or more domain-specific AI models implemented in the remote computing environment 304. Further, the generalized autonomous intelligent agent 102 and the generalized autonomous intelligent agent 306 may establish communications channels amongst these domain-specific AI models to facilitate collaboration amongst these domain-specific AI models in generating responses to the provided IoT data.

In an embodiment, if the identified domain-specific AI model cluster or committee is associated solely with domain-specific AI models 308 implemented in the remote computing environment 304, the generalized autonomous intelligent agent 102 may transmit the IoT data to the generalized autonomous intelligent agent 306 operating within the remote computing environment 304. The generalized autonomous intelligent agent 306 may disseminate the IoT data to the domain-specific AI models 308 within the remote computing environment 304 based on the definition of the identified cluster or committee within a world knowledge graph, as described above. In some instances, as the domain-specific AI models 308 generate responses to the IoT data, the generalized autonomous intelligent agent 306 implemented in the remote computing environment 304 may evaluate these responses according to the aforementioned methodologies described above in connection with FIG. 2. For instance, the generalized autonomous intelligent agent 306 may dynamically process the responses generated by the domain-specific AI models 308 according to any applicable ethical rules or standards to ensure that these responses do not cause unintended consequences. This may include performing emotion-informed risk assessment to consider emotional aspects when evaluating risks and potential outcomes from providing the generated response to a user. Further, if the responses include executable instructions that may be executed by one or more devices and/or sensors 108 within the user environment 110, the generalized autonomous intelligent agent 306 may evaluate these executable instructions to determine whether their execution would result in unintended consequences for users within the user environment 110, the one or more devices and/or sensors 108, and the user environment 110 in general.

If the generalized autonomous intelligent agent 102 receives a tailored response from the generalized autonomous intelligent agent 306 (as generated through the methodologies described above in connection with FIG. 2 and based on responses provided by the domain-specific AI models 308), the generalized autonomous intelligent agent 102 may perform additional processing of the tailored response prior to providing this tailored response to a user and/or the devices/sensors 108 implemented in the user environment 110. For example, the generalized autonomous intelligent agent 102 may perform the methodologies described above in connection with FIG. 2 to ensure that the tailored response comports with any applicable rules and standards and addresses the issues identified based on the received IoT data. Through this additional evaluation, the generalized autonomous intelligent agent 102 may further modify the tailored response prior to dissemination to the user and/or the devices/sensors 108 within the user environment 110.

Once the generalized autonomous intelligent agent 102 has finalized a response for delivery to the user and/or one or more devices and/or sensors 108, the generalized autonomous intelligent agent 102 may communicate this response to the user 106 and/or one or more devices and/or sensors 108. In an embodiment, the generalized autonomous intelligent agent 102 monitors subsequent communications among the user, the one or more devices and sensors 108, and the generalized autonomous intelligent agent 102 to obtain feedback with regard to provided response. The generalized autonomous intelligent agent 102 may continuously execute CRL using FMAL to further reinforce and/or update the generalized autonomous intelligent agent 102 and the domain-specific AI models 302 implemented on the IoT device 104. Returning to an earlier example, as users and different devices and sensors 108 provide feedback with regard to provided responses, the generalized autonomous intelligent agent 102 may determine whether these responses successfully addressed the corresponding intents. For instance, if a user indicates that a response is unsatisfactory (e.g., the response was incorrect, the response did not comport with the user’s expectations, the response was not responsive to the user prompt, etc.), the generalized autonomous intelligent agent 102 may evaluate this feedback to determine the areas of improvement that should be addressed to improve response accuracy. Similarly, if the generalized autonomous intelligent agent 102 obtains new data from the devices and sensors 108 within the user environment 110 and determines that the previously expressed intent was not addressed, the generalized autonomous intelligent agent 102 may use this new data as feedback that may be used to determine the areas of improvement that should be addressed to better resolve the expressed intent.

In some instances, if the feedback corresponds to a tailored response generated by the generalized autonomous intelligent agent 306 within the remote computing environment 304, the generalized autonomous intelligent agent 102 may transmit this feedback to the generalized autonomous intelligent agent 306. The generalized autonomous intelligent agent 306 may perform the aforementioned feedback process to update the domain-specific AI models 308 implemented in the remote computing environment 304.

In an embodiment, the generalized autonomous intelligent agent 102 and the generalized autonomous intelligent agent 306 may each implement SAIL or other feedback loops whereby the these generalized autonomous intelligent agents may automatically evaluate their performance, identify areas for improvement, and autonomously apply updates to improve their performance. For instance, using SAIL, the generalized autonomous intelligent agent 102 and the generalized autonomous intelligent agent 306 may each evaluate relevant feedback corresponding to provided responses and accordingly annotate these responses in order to refine their capabilities in processing different inputs (i.e., user prompts and/or data from different devices and sensors 108) and evaluating responses prior to dissemination to users and different devices and sensors 108 over time.

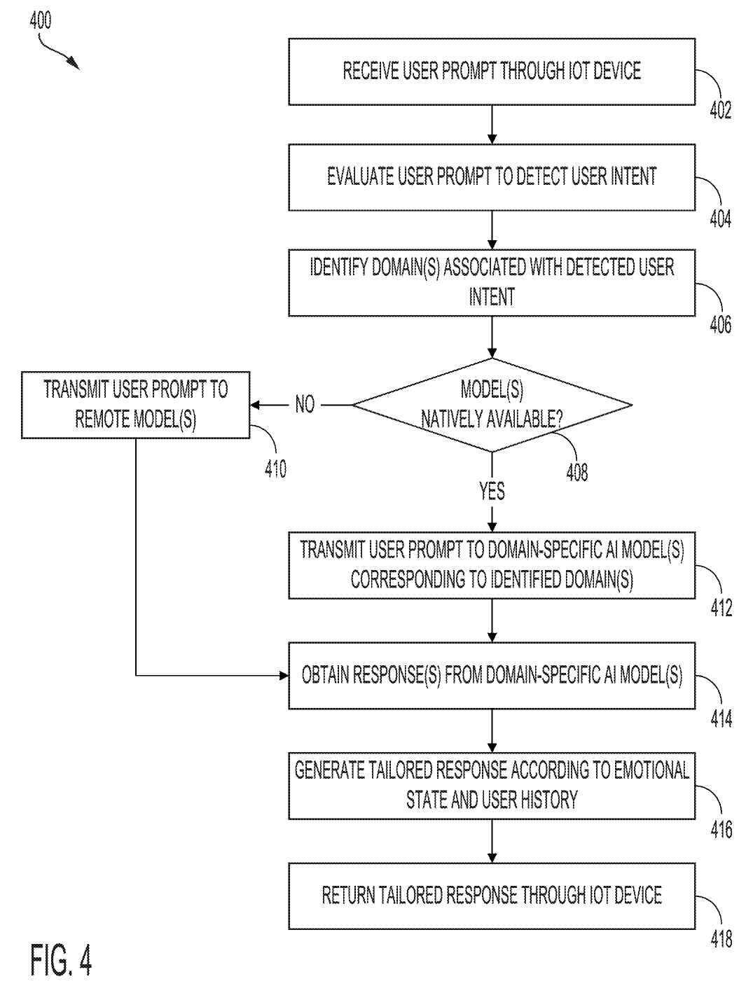

FIG. 4 shows an illustrative example of a process 400 for autonomously generating responses to user prompts through domain-specific AI models and emotional intelligence processing in accordance with at least one embodiment. The process 400 may be performed by a generalized autonomous intelligent agent implemented on an IoT device within a particular user environment.

At step 402, the generalized autonomous intelligent agent implemented on an IoT device within the particular user environment may receive a user prompt through this IoT device. For instance, if the IoT device is integrated with an agent interface through which users may engage with the generalized autonomous intelligent agent, the user may interact with this agent interface to submit a user prompt. As another illustrative example, if the IoT device is a smart speaker, through which users can communicate with the generalized autonomous intelligent agent through voice commands or other audial inputs, the user may submit their user prompt through a vocal command or other audial input to the IoT device, which may provide this vocal command or other audial input to the generalized autonomous intelligent agent. The IoT device may allow the user to submit their user prompt through other control inputs, such as through a controller, remote-control device, and the like.

At step 404, the generalized autonomous intelligent agent may evaluate the received user prompt to detect a user intent. For instance, the generalized autonomous intelligent agent may employ NLP techniques (including NER and dependency parsing) to convert the received user prompt into a set of prompt embeddings that may be used to identify the expressed user intent. An intent may (for example) be a topic, sentiment, complexity, and/or level of urgency. A topic can include, but is not limited to, a subject, a product, a service, a technical issue, a use question, a complaint, etc. In an embodiment, the generalized autonomous intelligent agent may maintain a set of intent embeddings corresponding to known intents previously encountered by the generalized autonomous intelligent agent and/or that the generalized autonomous intelligent agent is trained to identify from submitted user prompts. Thus, to detect the expressed user intent, the generalized autonomous intelligent agent may compare the set of prompt embeddings corresponding to the user prompt to the set of intent embeddings to identify matching intent embeddings. From these matching intent embeddings, the generalized autonomous intelligent agent may determine the user’s expressed intent.

At step 406, the generalized autonomous intelligent agent may identify one or more domains associated with the identified intent. As noted above, the generalized autonomous intelligence agent may maintain a world knowledge graph representation of the different clusters or committees of domain-specific AI models that may be leveraged to generate responses to user prompts. This world knowledge graph may be implemented through a data structure that represents the different domain-specific AI models maintained by the generalized autonomous intelligent agent through the IoT device as individual nodes and any corresponding relationships among these models using edges. Additionally, the world knowledge graph may represent different domain-specific AI models maintained by other generalized autonomous intelligent agents through different remote computing environments as additional individual nodes and any corresponding relationships among these models and the domain-specific AI models implemented on the IoT device using edges. The world knowledge graph may further denote the different domains or other areas of influence associated with each of these individual nodes, which may be used to define the different clusters or committees of domain-specific AI models implemented by the generalized autonomous intelligent agent on the IoT device and/or domain-specific AI models implemented in different remote computing environments.

At step 408, based on the user intent and identified domains, the generalized autonomous intelligent agent may determine whether the domain-specific AI models required to process the user prompt are natively available through the IoT device. As noted above, domain-specific AI models may be implemented through the IoT device and/or remote computing environments based on the computational and network resources associated with the IoT device and processing requirements. For example, based on the resource requirements for different domain-specific AI models and the known resources associated with the IoT device, the generalized autonomous intelligent agent may dynamically determine whether to implement the domain-specific AI models within the IoT device or through a remote computing environment. As another illustrative example, the generalized autonomous intelligent agent may automatically select a method for implementing the domain-specific AI models according to cost considerations, latency requirements, and the like.

If the generalized autonomous intelligent agent determines that the required domain-specific AI models associated with a selected domain-specific AI model cluster or committee are implemented through one or more remote computing environments, the generalized autonomous intelligent agent, at step 410, may transmit the user prompt to these domain-specific AI models within the one or more remote computing environments. For instance, the generalized autonomous intelligent agent may transmit the user prompt to other generalized autonomous intelligent agents operating within these one or more remote computing environments. These other generalized autonomous intelligent agents, using the world knowledge graph, may disseminate the user prompt to the domain-specific AI models associated with the selected domain-specific AI model cluster or committee to solicit responses to the user prompt.

If the generalized autonomous intelligent agent determines that the required domain-specific AI models are natively available through the IoT device, the generalized autonomous intelligent agent, at step 412, may transmit the user prompt to the domain-specific AI models corresponding to the identified knowledge domains and associated with the selected domain-specific AI model cluster or committee. In an embodiment, the domain-specific AI models associated with a particular cluster or committee may individually process an obtained user prompt to generate a response according to the knowledge domain of the domain-specific AI model. The individual domain-specific AI models may further evaluate the world knowledge graph to provide any outputs to other domain-specific AI models within the cluster or committee that may require these outputs in order to generate additional outputs responsive to the user prompt. This process allows the different domain-specific AI models within a cluster or committee to collaboratively process a user prompt according to their individual knowledge domains to generate a cohesive and comprehensive response to the user prompt. Further, each domain-specific AI model may review and refine any outputs generated by the different domain-specific AI models within a cluster or committee to ensure response accuracy.

At step 414, the generalized autonomous intelligent agent implemented on the IoT device may obtain one or more responses from the domain-specific AI models associated with the selected domain-specific AI model cluster or committee. At step 416, the generalized autonomous intelligent agent may select a response to the user prompt and tailor this response according to the emotional state of the user and the user’s own personal history. As noted above, the generalized autonomous intelligent agent is implemented using the LIDA architecture, whereby the generalized autonomous intelligent agent may leverage one or more special-purpose modules to evaluate any responses generated by one or more domain-specific AI models from a given cluster or committee to generate a comprehensive response to a user prompt. For instance, if two or more domain-specific AI models produce conflicting responses to a user prompt, the generalized autonomous intelligent agent, through the one or more special-purpose modules implemented through the LIDA architecture, may dynamically weigh each response according to the intent expressed by the user in their user prompt and the particular knowledge domains of the domain-specific AI models submitting proposed responses.

As noted above, the generalized autonomous intelligent agent is further trained to provide an emotion-based response based on historical user characteristics and sentiment analysis associated with the submitted user prompt. For instance, through evaluation of the expressed keywords, phrases, or other terms in the user prompt, the generalized autonomous intelligent agent may determine the user’s current sentiment or emotional state. In an embodiment, the generalized autonomous intelligent agent leverages a historical user datastore to construct a personal history of the user that may be used to tailor responses to user prompts from the user that comport with the user’s emotional state at any given time or otherwise with the user’s idiosyncrasies. As noted above, the generalized autonomous intelligent agent may implement a PIN algorithm that is trained to construct a coherent narrative from filtered experiences associated with the user over time. These filtered experiences may be maintained within the historical user datastore based on historical communications sessions between the user and the generalized autonomous intelligent agent over time. The PIN algorithm may perform narrative segmentation of these exchanged communications by dividing these communications into different segments according to detected themes, events, goals, and the like. Further, the PIN algorithm may organize these different segments into a chronological structure while highlighting key developments and achievements. The PIN algorithm may assign weights to each of these segments based on emotional significance such that user prompts identified as having greater emotional significance to the user may be given greater emphasis and addressed. Further, through the PIN algorithm, the generalized autonomous intelligent agent may generate a user profile that may be used to define an emotion-based response strategy (i.e., tailored personality) for responding to user prompts. In some instances, the generalized autonomous intelligent agent may periodically analyze the user profile and corresponding narrative segmentation and structuring to identify any patterns, biases, or areas for improvement in agent performance. Through this analysis, the generalized autonomous intelligent agent may update the user profile associated with the user and improve its tailoring of responses to user prompts according to any updated user characteristics.

Through the aforementioned LIDA architecture and the PIN algorithm, the generalized autonomous intelligent agent may generate a tailored response to the user prompt that incorporates the user’s current emotional state and their user history (including any user idiosyncrasies) and that addresses the user’s expressed intent. In some instances, the generalized autonomous intelligent agent may further process this tailored response through an autonomous ethical oversight module to further ensure that the tailored response comports with any applicable ethical rules or standards, ensuring that the generalized autonomous intelligent agent and the domain-specific AI models are not misused or otherwise do not cause unintended consequences. For instance, the generalized autonomous intelligent agent, through this module, may perform emotion-informed risk assessment to consider emotional aspects when evaluating risks and potential outcomes from providing the generated response to the user. Based on this evaluation, the generalized autonomous intelligent agent may further modify the tailored response to remove any information or other data that may be problematic, thereby addressing any ethical dilemmas detected by the autonomous ethical oversight module.

At step 418, the generalized autonomous intelligent agent may return the tailored response to the user through the IoT device. For instance, the generalized autonomous intelligent agent may format the tailored response according to the media used by the IoT device. For example, if the user prompt was submitted through a smart speaker device, the generalized autonomous intelligent agent may transmit the tailored response through an audial output (such as through a voice generator). This audial output may be tailored according to the known user preferences and profile. If the IoT device implements a GUI or other interface through which responses may be displayed, the generalized autonomous intelligent agent may dynamically update the GUI or other interface to display the tailored response.

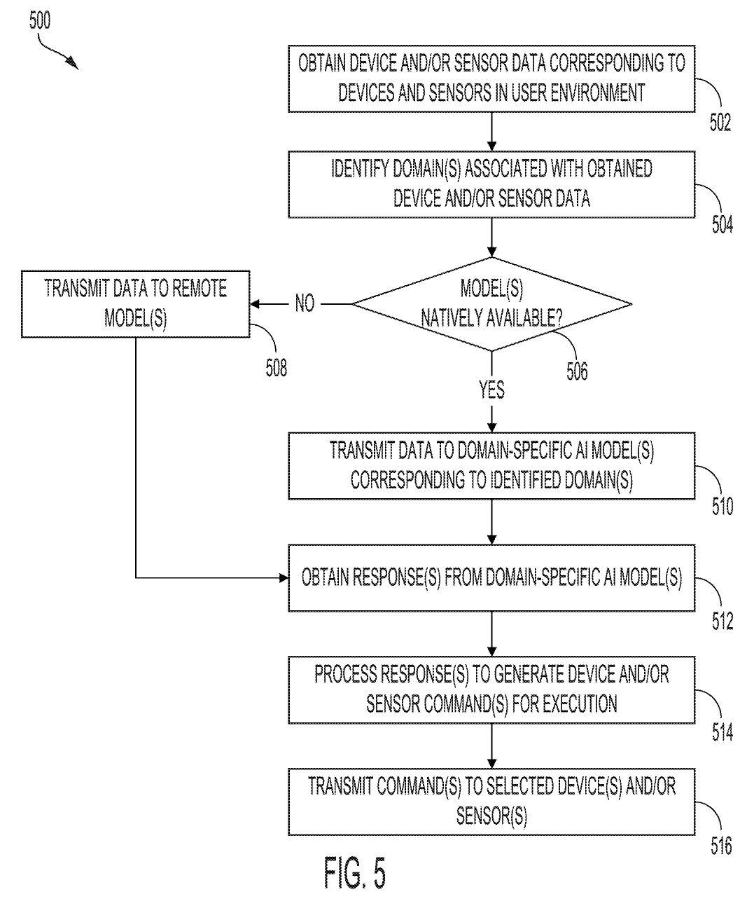

FIG. 5 shows an illustrative example of a process 500 for autonomously processing device and sensor data corresponding to different devices and sensors implemented in a user environment to generate tailored executable instructions and commands for the different devices and sensors in accordance with at least one embodiment. The process 500 may be performed by a generalized autonomous intelligent agent implemented on an IoT device within a particular user environment.

At step 502, the generalized autonomous intelligent agent implemented on an IoT device within a particular user environment may obtain device and/or sensor data corresponding to different devices and/or sensors implemented in the particular user environment. As noted above, the IoT device may be connected to the one or more devices and sensors within the user environment through communications sessions established according to one or more IoT protocols and/or other communications protocols. The generalized autonomous intelligent agent may continuously receive IoT data from these different devices and sensors in real-time as the IoT data is generated by these different devices and sensors.

At step 504, the generalized autonomous intelligent agent may identify one or more knowledge domains associated with the received IoT data. As noted above, the generalized autonomous intelligent agent may dynamically process this IoT data to determine whether this IoT data is indicative of a need to perform one or more operations within the user environment. If the IoT data is indicative of a need to perform one or more operations within the user environment, the generalized autonomous intelligent agent may annotate this IoT data to indicate this need to perform one or more operations to address the identified issues. In an embodiment, based on the identified issue, the generalized autonomous intelligent agent may identify a set of knowledge domains required to address this issue. For example, different issues may correspond to different intents. Accordingly, the generalized autonomous intelligence agent may leverage a world knowledge graph representation of the different clusters or committees of domain-specific AI models to identify a particular domain-specific AI model cluster or committee corresponding to the particular issue. As noted above, this world knowledge graph may be implemented through a data structure that represents the different domain-specific AI models maintained by the generalized autonomous intelligent agent through the IoT device as individual nodes and any corresponding relationships among these models using edges. Additionally, the world knowledge graph may represent different domain-specific AI models maintained by other generalized autonomous intelligent agents through different remote computing environments as additional individual nodes and any corresponding relationships among these models and the domain-specific AI models implemented on the IoT device using edges. The world knowledge graph may further denote the different domains or other areas of influence associated with each of these individual nodes, which may be used to define the different clusters or committees of domain-specific AI models implemented by the generalized autonomous intelligent agent on the IoT device and/or domain-specific AI models implemented in different remote computing environments. Thus, through the identification of a particular domain-specific AI model cluster or committee, the generalized autonomous intelligent agent may identify the different knowledge domains associated with the obtained IoT data and corresponding issue.

At step 506, based on the identified issue and corresponding knowledge domains, the generalized autonomous intelligent agent may determine whether the domain-specific AI models required to process the IoT data are natively available through the IoT device. As noted above, domain-specific AI models may be implemented through the IoT device and/or remote computing environments based on the computational and network resources associated with the IoT device and processing requirements. For example, based on the resource requirements for different domain-specific AI models and the known resources associated with the IoT device, the generalized autonomous intelligent agent may dynamically determine whether to implement the domain-specific AI models within the IoT device or through a remote computing environment. As another illustrative example, the generalized autonomous intelligent agent may automatically select a method for implementing the domain-specific AI models according to cost considerations, latency requirements, and the like.

If the generalized autonomous intelligent agent determines that the required domain-specific AI models associated with a selected domain-specific AI model cluster or committee are implemented through one or more remote computing environments, the generalized autonomous intelligent agent, at step 508, may transmit the IoT data and other information corresponding to the identified issue to these domain-specific AI models within the one or more remote computing environments. For instance, the generalized autonomous intelligent agent may transmit the IoT data and other information to other generalized autonomous intelligent agents operating within these one or more remote computing environments. These other generalized autonomous intelligent agents, using the world knowledge graph, may disseminate the IoT data and other information to the domain-specific AI models associated with the selected domain-specific AI model cluster or committee to solicit responses that may be used to address the identified issue.

If the generalized autonomous intelligent agent determines that the required domain-specific AI models are natively available through the IoT device, the generalized autonomous intelligent agent, at step 510, may transmit the IoT data and other information associated with the identified issue to the domain-specific AI models corresponding to the identified knowledge domains and associated with the selected domain-specific AI model cluster or committee. In an embodiment, the domain-specific AI models associated with a particular cluster or committee may individually process the IoT data and other information to generate a response according to the knowledge domain of the domain-specific AI model. The individual domain-specific AI models may further evaluate the world knowledge graph to provide any outputs to other domain-specific AI models within the cluster or committee that may require these outputs in order to generate additional outputs responsive to the IoT data and other information. This process allows the different domain-specific AI models within a cluster or committee to collaboratively process IoT data and other information according to their individual knowledge domains to generate a cohesive and comprehensive response to the IoT data and other information. Further, each domain-specific AI model may review and refine any outputs generated by the different domain-specific AI models within a cluster or committee to ensure response accuracy.

At step 512, the generalized autonomous intelligent agent implemented on the IoT device may obtain one or more responses from the domain-specific AI models associated with the selected domain-specific AI model cluster or committee. At step 514, the generalized autonomous intelligent agent may process the obtained responses to generate a set of device and/or sensor commands that may be executed by one or more devices and/or sensors within the user environment to address the identified issue. For instance, if the obtained responses from the domain-specific AI models include executable instructions that may be executed by one or more devices and/or sensors within the user environment to perform a desired operation, the generalized autonomous intelligent agent may evaluate these executable instructions to determine whether their execution would result in unintended consequences for the user, the one or more devices and/or sensors, and the user environment as a whole. For example, if execution of the executable instructions would result in one or more devices and/or sensors operating beyond their capabilities, increasing potential risk to these one or more devices and/or sensors and to the user, the generalized autonomous intelligent agent may modify the executable instructions to ensure that execution of these modified executable instructions would not result in such undesired operation. As another illustrative example, if execution of the executable instructions would result in hazardous conditions for the user within the user environment, the generalized autonomous intelligent agent may dynamically modify these executable instructions to prevent the one or more devices and/or sensors from creating these hazardous conditions.

At step 514, the generalized autonomous intelligent agent may transmit the finalized commands to the applicable devices and/or sensors within the user environment for execution in order to address the identified issue. For instance, once the generalized autonomous intelligent agent has finalized the set of commands for delivery to the one or more devices and/or sensors, the generalized autonomous intelligent agent may communicate these commands, through the communications sessions established between these devices and/or sensors and the IoT device, to the one or more devices and/or sensors. In an embodiment, the generalized autonomous intelligent agent monitors subsequent communications among the user, the one or more devices and sensors, and the generalized autonomous intelligent agent to obtain feedback with regard to execution of these commands and resolution of the identified issue, as described above.

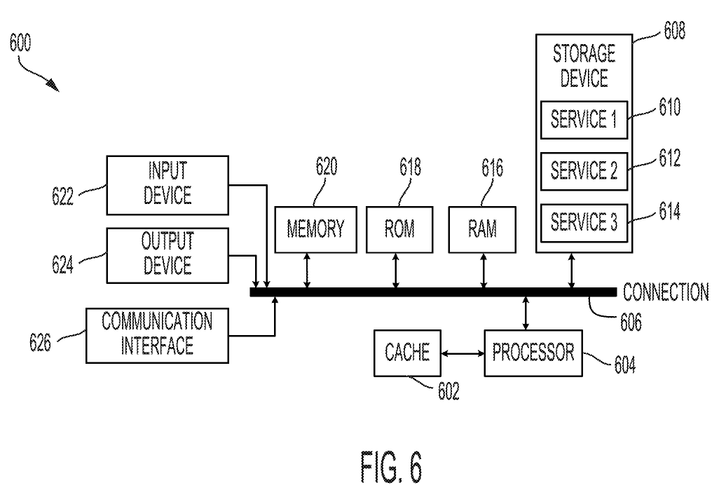

FIG. 6 illustrates a computing system architecture 600 including various components in electrical communication with each other using a connection 606, such as a bus, in accordance with some implementations. Example system architecture 600 includes a processing unit (CPU or processor) 604 and a system connection 606 that couples various system components including the system memory 620, such as ROM 618 and RAM 616, to the processor 604. The system architecture 600 can include a cache 602 of high-speed memory connected directly with, in close proximity to, or integrated as part of the processor 604. The system architecture 600 can copy data from the memory 620 and/or the storage device 608 to the cache 602 for quick access by the processor 604. In this way, the cache can provide a performance boost that avoids processor 604 delays while waiting for data. These and other modules can control or be configured to control the processor 604 to perform various actions.

Other system memory 620 may be available for use as well. The memory 620 can include multiple different types of memory with different performance characteristics. The processor 604 can include any general purpose processor and a hardware or software service, such as service 1610, service 2612, and service 3614 stored in storage device 608, configured to control the processor 604 as well as a special-purpose processor where software instructions are incorporated into the actual processor design. The processor 604 may be a completely self-contained computing system, containing multiple cores or processors, a bus, memory controller, cache, etc. A multi-core processor may be symmetric or asymmetric.

To enable user interaction with the computing system architecture 600, an input device 622 can represent any number of input mechanisms, such as a microphone for speech, a touch-sensitive screen for gesture or graphical input, keyboard, mouse, motion input, speech and so forth. An output device 624 can also be one or more of a number of output mechanisms known to those of skill in the art. In some instances, multimodal systems can enable a user to provide multiple types of input to communicate with the computing system architecture 600. The communications interface 626 can generally govern and manage the user input and system output. There is no restriction on operating on any particular hardware arrangement and therefore the basic features here may easily be substituted for improved hardware or firmware arrangements as they are developed.

Storage device 608 is a non-volatile memory and can be a hard disk or other types of computer readable media which can store data that are accessible by a computer, such as magnetic cassettes, flash memory cards, solid state memory devices, digital versatile disks, cartridges, RAMs 616, ROM 618, and hybrids thereof.

The storage device 608 can include services 610, 612, 614 for controlling the processor 604. Other hardware or software modules are contemplated. The storage device 608 can be connected to the system connection 606. In one aspect, a hardware module that performs a particular function can include the software component stored in a computer-readable medium in connection with the necessary hardware components, such as the processor 604, connection 606, output device 624, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
detecting a user prompt, wherein the user prompt is associated with an intent, and wherein the user prompt is received through a generalized autonomous intelligent agent implemented on an Internet-of-Things (IoT) device operating in a user environment;
processing the user prompt to identify an intent, wherein the intent is associated with one or more knowledge domains;
identifying a set of domain-specific artificial intelligence models trained according to the one or more knowledge domains;
transmitting the user prompt to the set of domain-specific artificial intelligence models to solicit a response to the user prompt, wherein when the user prompt is received by the set of domain-specific artificial intelligence models, the set of domain-specific artificial intelligence models collaboratively process the user prompt according to the one or more knowledge domains to generate a set of responses;
evaluating the set of responses to generate a tailored response according to a set of user characteristics associated with a user;
transmitting the tailored response through the IoT device operating in the user environment; and
dynamically updating the generalized autonomous intelligent agent, the set of domain-specific artificial intelligence models, and the set of user characteristics according to feedback associated with the tailored response, wherein the feedback is obtained through the IoT device.

2. The computer-implemented method of claim 1, wherein the set of domain-specific artificial intelligence models is implemented in a remote computing environment, and wherein the user environment and the remote computing environment are distinct.

3. The computer-implemented method of claim 1, wherein the tailored response includes one or more executable commands that, when executed by one or more other IoT devices within the user environment, cause the one or more other IoT devices to perform a set of operations to address the intent.

4. The computer-implemented method of claim 1, wherein the user prompt further includes IoT data corresponding to one or more other IoT devices within the user environment, and wherein the IoT data is processed by the generalized autonomous intelligent agent to identify the intent.

5. The computer-implemented method of claim 1, wherein the feedback includes IoT data corresponding to one or more other IoT devices within the user environment, and wherein the IoT data is evaluated by the generalized autonomous intelligent agent to determine whether the intent has been addressed.

6. The computer-implemented method of claim 1, further comprising:
identifying a new knowledge domain corresponding to the intent;
training a new domain-specific artificial intelligence model according to the new knowledge domain, wherein the new domain-specific artificial intelligence model is trained by extracting data from different data sources corresponding to the new knowledge domain; and
transmitting the user prompt to the new domain-specific artificial intelligence model, wherein when the user prompt is received by the new domain-specific artificial intelligence model, the new domain-specific artificial intelligence model collaboratively processes the user prompt with the set of domain-specific artificial intelligence models to generate a new response.

7. The computer-implemented method of claim 1, wherein the set of responses is further evaluated by another generalized autonomous intelligent agent implemented in a remote computing environment to obtain an additional tailored response to the user prompt, and wherein the additional tailored response is transmitted through the IoT device operating in the user environment.

8. A system, comprising:
one or more processors; and
memory storing thereon instructions that, as a result of being executed by the one or more processors, cause the system to:
detect a user prompt, wherein the user prompt is associated with an intent, and wherein the user prompt is received through a generalized autonomous intelligent agent implemented on an Internet-of-Things (IoT) device operating in a user environment;
process the user prompt to identify an intent, wherein the intent is associated with one or more knowledge domains;
identify a set of domain-specific artificial intelligence models trained according to the one or more knowledge domains;
transmit the user prompt to the set of domain-specific artificial intelligence models to solicit a response to the user prompt, wherein when the user prompt is received by the set of domain-specific artificial intelligence models, the set of domain-specific artificial intelligence models collaboratively process the user prompt according to the one or more knowledge domains to generate a set of responses;
evaluate the set of responses to generate a tailored response according to a set of user characteristics associated with a user;
transmit the tailored response through the IoT device operating in the user environment; and
dynamically update the generalized autonomous intelligent agent, the set of domain-specific artificial intelligence models, and the set of user characteristics according to feedback associated with the tailored response, wherein the feedback is obtained through the IoT device.

9. The system of claim 8, wherein the set of domain-specific artificial intelligence models is implemented in a remote computing environment, and wherein the user environment and the remote computing environment are distinct.

10. The system of claim 8, wherein the tailored response includes one or more executable commands that, when executed by one or more other IoT devices within the user environment, cause the one or more other IoT devices to perform a set of operations to address the intent.

11. The system of claim 8, wherein the user prompt further includes IoT data corresponding to one or more other IoT devices within the user environment, and wherein the IoT data is processed by the generalized autonomous intelligent agent to identify the intent.

12. The system of claim 8, wherein the feedback includes IoT data corresponding to one or more other IoT devices within the user environment, and wherein the IoT data is evaluated by the generalized autonomous intelligent agent to determine whether the intent has been addressed.

13. The system of claim 8, wherein the instructions further cause the system to:
identify a new knowledge domain corresponding to the intent;
train a new domain-specific artificial intelligence model according to the new knowledge domain, wherein the new domain-specific artificial intelligence model is trained by extracting data from different data sources corresponding to the new knowledge domain; and
transmit the user prompt to the new domain-specific artificial intelligence model, wherein when the user prompt is received by the new domain-specific artificial intelligence model, the new domain-specific artificial intelligence model collaboratively processes the user prompt with the set of domain-specific artificial intelligence models to generate a new response.

14. The system of claim 8, wherein the set of responses is further evaluated by another generalized autonomous intelligent agent implemented in a remote computing environment to obtain an additional tailored response to the user prompt, and wherein the additional tailored response is transmitted through the IoT device operating in the user environment.

15. A non-transitory computer-readable storage medium storing thereon executable instructions that, as a result of being executed by one or more processors of a computer system, cause the computer system to:
detect a user prompt, wherein the user prompt is associated with an intent, and wherein the user prompt is received through a generalized autonomous intelligent agent implemented on an Internet-of-Things (IoT) device operating in a user environment;
process the user prompt to identify an intent, wherein the intent is associated with one or more knowledge domains;
identify a set of domain-specific artificial intelligence models trained according to the one or more knowledge domains;
transmit the user prompt to the set of domain-specific artificial intelligence models to solicit a response to the user prompt, wherein when the user prompt is received by the set of domain-specific artificial intelligence models, the set of domain-specific artificial intelligence models collaboratively process the user prompt according to the one or more knowledge domains to generate a set of responses;
evaluate the set of responses to generate a tailored response according to a set of user characteristics associated with a user;
transmit the tailored response through the IoT device operating in the user environment; and
dynamically update the generalized autonomous intelligent agent, the set of domain-specific artificial intelligence models, and the set of user characteristics according to feedback associated with the tailored response, wherein the feedback is obtained through the IoT device.

16. The non-transitory computer-readable storage medium of claim 15, wherein the set of domain-specific artificial intelligence models is implemented in a remote computing environment, and wherein the user environment and the remote computing environment are distinct.

17. The non-transitory computer-readable storage medium of claim 15, wherein the tailored response includes one or more executable commands that, when executed by one or more other IoT devices within the user environment, cause the one or more other IoT devices to perform a set of operations to address the intent.

18. The non-transitory computer-readable storage medium of claim 15, wherein the user prompt further includes IoT data corresponding to one or more other IoT devices within the user environment, and wherein the IoT data is processed by the generalized autonomous intelligent agent to identify the intent.

19. The non-transitory computer-readable storage medium of claim 15, wherein the feedback includes IoT data corresponding to one or more other IoT devices within the user environment, and wherein the IoT data is evaluated by the generalized autonomous intelligent agent to determine whether the intent has been addressed.

20. The non-transitory computer-readable storage medium of claim 15, wherein the executable instructions further cause the computer system to:
identify a new knowledge domain corresponding to the intent;
train a new domain-specific artificial intelligence model according to the new knowledge domain, wherein the new domain-specific artificial intelligence model is trained by extracting data from different data sources corresponding to the new knowledge domain; and
transmit the user prompt to the new domain-specific artificial intelligence model, wherein when the user prompt is received by the new domain-specific artificial intelligence model, the new domain-specific artificial intelligence model collaboratively processes the user prompt with the set of domain-specific artificial intelligence models to generate a new response.

21. The non-transitory computer-readable storage medium of claim 15, wherein the set of responses is further evaluated by another generalized autonomous intelligent agent implemented in a remote computing environment to obtain an additional tailored response to the user prompt, and wherein the additional tailored response is transmitted through the IoT device operating in the user environment.
